(19) United States
(12) Patent Application Publication
(10) Pub. No.: US 2006/0117365 A1
(43) Pub. Date: Jun. 1, 2006

(54) Stream output device and information providing device

(76) Inventors: Toru Ueda, Kyoto (JP); Naoki Urano, Osaka (JP); Iwao Ishibashi, Hiroshima (JP)

Correspondence Address: BIRCH STEWART KOLASCH & BIRCH, PO BOX 747, FALLS CHURCH, VA, 22040-0747, US

(21) Appl. No.: 10/543,657

(22) PCT Filed: Feb. 2, 2004
(86) PCT No.: PCT/JP04/01020

§ 371 Date: Jul. 28, 2005

(30) Foreign Application Priority Data
Feb. 14, 2003 (JP) 2003-035950
Apr. 10, 2003 (JP) 2003-106095
Jul. 25, 2003 (JP) 2003-201756

(51) Int. Cl. H04N 7/173

(52) U.S. Cl. 725/112; 725/100; 725/113; 725/131

(57) ABSTRACT

A stream output apparatus (50) includes a sequence information obtaining apparatus (106) for obtaining sequence information representing a reproduction sequence of stream data, and a sequencer apparatus (110) obtaining stream data ready for use with the sequence information obtained by the sequence information obtaining apparatus (106) and outputting the data in accordance with the sequence designated by the sequence information.

### TECHNICAL FIELD

The present invention relates to a stream output apparatus outputting one or both of video images and music to a user, and to an information providing apparatus used therewith. Specifically, the present invention relates to a stream output apparatus capable of re-configuring and outputting streams in such an order and configuration that fit for the purpose of the user, and to an information providing apparatus therefor.

### BACKGROUND ART

Along with the development of digital technique, digital processing of information that has conventionally been processed in analogue manner has become increasingly common. Examples include digital television broadcast, a so-called web radio through the Internet and video streaming. Particularly a technique of storing digital information of a movie or music in a server computer on a network, successively transmitting the information to a client computer through the network and reproducing the digital information as such on a client has been expanding. Such a technique is generally referred to as streaming.

Development of a DVD (Digital Versatile Disc) allows recording of both video images and sounds of one movie on a single disc. This has promoted widespread use of DVD reproducing apparatuses. Further, dramatic increase of hard disk storage has lead to popular use of apparatuses that allow recording of contents such as TV (television) program and the like broadcast through streaming on a hard disk of large storage capacity and reproducing the same later, in addition to the packaged media represented by the DVDs.

Such apparatuses are referred to by various names. For example, there are apparatuses such as VTR (Video Tape Recorder) including analogue type ones, hard disk VTR, DVD player, CD (Compact Disc) player, a media server and the like.

Further, as means for editing recorded video images and sound, there is software operating on a personal computer. Particularly, such processing at home has come to be common, as the hard disk storage increased dramatically in these days and high-performance computers become inexpensive.

A large number of apparatuses have been known for professional use for editing video images and the like. Among these, Japanese Patent Laying-Open No. 2002-232827 proposes a video and audio editing system, which will be discussed later. The system proposed in Japanese Patent Laying-Open No. 2002-232827 includes a server having a function of performing special edition of video images and the like, and a client editing apparatus operated by the user for editing video images. Material data and editing function are concentrated on the server, and what is left for the client is only the function of editing operation. When the user wishes to carry out a specific editing work while editing video data and the like, he/she transmits the video data to the server. The server performs a designated editing work on the video data, and returns the result to the originating client editing apparatus. This realizes a desired function without providing each client editing apparatus with the function of performing such an editing work. When a new type of editing work is to be added, what is necessary is the addition of the function only to the server, and it is unnecessary to add the function to each client editing apparatus.

Japanese Patent Laying-Open No. 2002-300523 describes apparatus and method of connecting various apparatuses through a network and editing streams distributed over the various apparatuses. According to the apparatus and method described in this laid-open application, materials of the streams distributed and stored in various apparatuses are gathered at one portion, and compressed sub-material is formed. The sub-material is decoded and reproduced, and while viewing video images displayed on a monitor, reproduction, fast-rewind or fast-forward operations are executed, to form an edit procedure list (EPL). The EPL is stored in an EPL server, and is read by a plurality of groups performing various edition processes, arranged dispersed on the network. Each group may edit the material in accordance with the EPL, or convert the material to searchable format, and save them. When the contents should actually be reproduced, necessary material can be obtained based on the description of EPL.

In this apparatus, actually, the contents editing work is realized by the EPL editing work. When editing an EPL, not the actual contents but sub-materials edited to alleviate the load of processing can be used in place of the actual contents. Thus, during the edition, workload on the apparatus or communication circuit for data transmission can be made smaller. Further, the EPL includes information designating a format and editing material embedded, and therefore, additional information is unnecessary when executing edition. Further, even when the contents forming apparatus has low performance and only an output of low quality is available, final product of high quality can be obtained.

Japanese Patent Laying-Open No. 2002-325221 describes a technique using information referred to as a play list, for reproducing information recorded on information recording medium such as DVD-RAM (Random Access Memory) and the like. In the system described in this laid-open application, a user-defined reproduction path information U-PCG (play list), prepared by the user and defining the order of reproducing information recorded on the information recording medium is up-loaded to a server. When another user downloads the play list that has been up-loaded on the server in association with a recording medium and adds the play list to the recording medium, it becomes possible to reproduce the information recorded on the recording medium in the order defined by the downloaded play list.

Japanese Patent Laying-Open No. 2001-285831 discloses a system for providing interactive advertisement through a linkage between broadcast and Internet advertisement. According to this system, information allowing access to an advertisement on the Internet, referred to as an advertisement scenario head, is embedded in digital broadcast data.

Japanese Patent Laying-Open No. 2001-285831 discloses a method of allowing reproduction of contents on an optical disk and allowing an access to Internet contents.

Japanese Patent Laying-Open No. 11-146359 discloses an apparatus that searches for a program based on character information recorded on a medium, and obtains information related to the program, to be used for program selection or reserved recording of the program.

Japanese Patent Laying-Open No. 9-500470 discloses a method of on-line auction using the Internet.

When the user uses information on the Internet, typically, a system referred to as World Wide Web (hereinafter referred to as the Web) is used. In this system, a terminal apparatus connects to a Web server apparatus through the Internet, and information is transferred therefrom and displayed or reproduced by the terminal apparatus.

This system has been widely used, as the operation on the terminal apparatus is simple. Generally, however, speed of communication is not sufficiently high, and therefore, it is difficult to hold moving pictures of high quality on the side of the server and to distribute in response to requests from a large number of users.

The broadcast system, on the other hand, is capable of sending video images of up to high-vision quality to a large number of viewers at one time. Packaged media such as CD and DVD are also capable of sending high-quality AV (Audio Visual) data of low cost to a large number of users.

It is difficult, however, to build a flexible interaction system by the broadcasting system and the packaged media by themselves. Particularly in the field of advertisement, interactive processing is desirable.

In digital broadcast, it is possible to build an interactive system by transmitting interactive contents through synchronization between data and broadcast. Preparation of data, however, takes time, as the broadcasting system itself is complicated. This poses a problem that a program cannot easily be changed or added.

Though it is possible to distribute motion pictures and the like through the Internet, broadcast or packaged media of the state of the art, it is difficult to distribute and reproduce on a user terminal only the portions requested by the user.

Specifically, a technique that partially reproduces stream data of motion picture, music or the like distributed to the user through broadcast, packaged media or the Internet, and to coordinate the same with interactive advertisement, has not yet been found to date.

According to the conventional art disclosed in Japanese Patent Laying-Open No. 2002-232827 or 2002-300523, basically, a video-image editor forms and edits edition information. The thus formed edition information is assumed to be used by specific users only, including the editor as a user. Though each device is connected to a network, the stream data is communicated only between these fixed devices, and editing takes place only in these fixed devices. The devices used for such editing are professional models, and therefore, formation of the editing information requires time and skill.

It is noted that the EPL in accordance with Japanese Patent Laying-Open No. 2002-300523 is created in order to facilitate editing specific video information. As edition of video information itself poses large burden on the apparatus, simplified version of material video information is attached to the EPL, and EPL is edited using the simplified video information. The EPL is a kind of substitute for the video information, and not independent from the video information. Therefore, when an interactive processing is to be realized using the EPL, another scheme for that purpose becomes necessary.

Usually, what a general user wants is to enjoy edited scenes only. Sumo and baseball digest programs are good examples. Such digest version is often broadcast in so-called sports news programs. A sport news program, however, has limited time, and therefore, at most only a few minutes of select scenes of a baseball game, for example, are broadcast although the game possibly takes two hours or more. Further, such a sport news program is broadcast on a predetermined program table, and not always available. Thus, a user must wait for the broadcast time.

In contrast, DVD-RAM and the like are consumer-oriented products. It is known from Japanese Patent Laying-Open No. 2002-325221 that, when information recorded on a specific recording medium represented by the DVD-RAM is to be reproduced, play list information is downloaded from the network and recorded on the same DVD-RAM to enable reproduction in accordance with the sequence.

The technique described in Japanese Patent Laying-Open No. 2002-325221 is adapted only for a specific recording medium of DVD-RAM, and it is not suitable for collectively handle stream data stored on other recording media such as hard disk, semiconductor memory or other terminal connected through the network. Effective linkage between such streams and information related to sales of products or services on the Web (such as the Internet shopping site and advertising site) is not at all discussed. There is a need for apparatus and method of reproducing general stream in a form preferred by the user, in a consumer-oriented apparatus, not limited to specific recording media and specific methods of recording/reproduction.

Particularly, according to the technique disclosed in this laid-open application, the play list information and the stream data are in one-to-one correspondence with each other. When there is no stream data at one's hand, downloading the play list information is meaningless. Even when data comparable to the stream data intended by the play list information is at hand (by way of example, the play list information relates to a baseball game broadcast by a first station and the data at hand is stream data obtained by recording the same game broadcast by a second station), the stream data at hand cannot be reproduced using the play list information, as the stream data is different from the intended one.

Therefore, a scheme allowing more flexible use of stream data is necessary.

According to Japanese Patent Laying-Open No. 2001-285831, access information to advertising information is embedded in the broadcast. This method is effective when a user watching a broadcast accesses an advertisement on the Internet. The server need not have any special function. In this example, however, a process of designating a specific portion of a specific stream by the server and reproducing the designated portion on the terminal side is impossible. Further, it is impossible to reproduce only some portions of broadcast program or packaged medium in synchronization with posting of advertisement contents on the side of the server.

Japanese Patent Laying-Open No. 2001-285831 describes multi-media reproduction from an optical disc and an access to the Internet. According to this technique, when contents stored in the optical disc are reproduced, access to the Internet is made in parallel, and contents on the Internet are reproduced.

According to this technique, however, the Internet is accessed at a predetermined scene of the contents. It is impossible to segment an arbitrary portion of the stream held on the local side (terminal apparatus receiving the contents), to reproduce the same on the terminal side, to have advertising information linked to the arbitrary portion transmitted through the Internet to the terminal and to reproduce the advertising information.

Japanese Patent Laying-Open No. 11-146359 discloses a method of searching for a program by the combination of a network and a CD-ROM. The technique is directed simply to such a search, and it does not provide any information for outputting or reproducing recorded stream.

For stream output, apparatus and method of reproducing not only the streams fixed on recording media but also contents provided on the network in a form preferred by the user are necessary. Further, there is a problem particular to the network; i.e., that streams may be provided from dispersed portions on the network. There is no technique for controlling a sequence of reproducing the streams from such dispersed stream sources.

Further, as the storage capacity of the recording media has been increasing, it is assumed that a large number of programs are recorded on one recording medium. It is also possible that motion pictures and music are recorded together. In such a situation, after down-loading play list information, it becomes necessary to determine for which stream the current play list is intended.

Further, when the user is to get information such as the play list for reproducing stream data in a desired sequence, it is desirable that collateral information indicating what type of information exists in devices on the network are presented to the user, to allow selection of the sequence information.

### DISCLOSURE OF THE INVENTION

Therefore, an object of the present invention is to provide apparatus and method of stream output, for reproducing stream common in consumer-oriented devices in a form preferred by the user, regardless of the type of recording medium and the method of recording/reproducing the stream.

Another object of the present invention is to provide apparatus and method of stream output, for reproducing stream in a form preferred by the user, not only for the stream fixed on a recording medium but also contents provided over a network.

A further object of the present invention is to provide apparatus and method of stream output, controlling a reproduction sequence of streams coming from dispersed stream sources.

A still further object of the present invention is to provide apparatus and method of stream output, making it unnecessary for the user to determine, after down-loading information designating a reproduction sequence, for which stream the information is intended.

A still further object of the present invention is to provide apparatus and method of stream output, which presents, when the user is to get sequence information for reproducing stream data in a desired sequence, collateral information to the user to allow selection of the sequence information.

A still further object of the present invention is to provide, together with the stream output apparatus described above, an information providing apparatus operating as a server apparatus.

An additional object of the present invention is to provide an information providing apparatus that can present, when the user searches for program information, information as to which order the programs are reproduced. This information will be referred to as sequence information.

Another object of the present invention is to provide an information providing apparatus by which the user can easily search for and get sequence information corresponding to a desired program.

A still further object of the present invention is to provide an information providing apparatus allowing the user to easily get sequence information corresponding to each program, by transmitting a program table page to the user.

According to a first aspect, the present invention provides a stream output apparatus, including: a sequence information obtaining unit for obtaining sequence information indicating a reproduction sequence of stream data; and a sequencer unit for obtaining stream data ready for use with the sequence information obtained by the sequence information obtaining unit and for outputting the stream data in accordance with a sequence designated by the sequence information.

The stream data corresponding to the obtained sequence information is obtained, and output in accordance with the sequence designated by the sequence information. As the stream data is automatically obtained in accordance with the sequence information, output of the stream data can freely be controlled by the sequence information. When such sequence information is prepared, it becomes possible for the user who gets the sequence information to view the stream data in the form edited in accordance the sequence information. When the sequence information is prepared such that stream data of various media are output in a desired sequence, it becomes possible for the stream output apparatus to integrate and output stream data on various media in accordance with the intention of the author of the sequence information.

The sequence information obtaining unit includes a message receiving unit for receiving an electronic message transmitted from an external device to the apparatus, and a sequence information extracting unit for extracting sequence information included in the message received by the message receiving unit; and the sequence information is extracted from a message transmitted to the stream output apparatus, and stream data corresponding to the sequence information is obtained and output.

The sequence information can be transmitted using an electronic message. When a user watching stream data in accordance with certain sequence information stops watching in the middle, the user may watch the remaining part of the stream data by another apparatus by transmitting the sequence information as an electronic message to the said another apparatus. From the viewpoint of a service provider preparing the sequence information, it is possible to actively present sequence information to taste of each user.

The sequence information obtaining unit may include a browser portion obtaining and displaying information held by an external device, and a unit for obtaining sequence information presented by the browser portion and corresponds to information selected by a user.

As the desired information presented by the browser portion is selected by the user, the sequence information obtaining unit can get the sequence information corresponding to the information. Thus, the sequence information desired by the user can easily be selected and obtained. It becomes possible for the user to check and select the desired one.

Here, the stream data output apparatus may further include a unit for determining whether stream data included in sequence information displayed by the browser portion is accessible from the stream output apparatus or not; and a unit for controlling the browser portion to display sequence information displayed by the browser portion in different manner depending on the result of determination by the determining unit.

If a stream data is inaccessible, getting the sequence information thereof is useless. Such a situation can easily be determined from the display of the browser, and therefore, the user can more accurately and easily determine whether the sequence information is to be obtained or not.

The stream output apparatus includes a stream receiving unit for receiving stream data from an external apparatus; and a stream storage unit for storing the received stream data; wherein the sequencer unit includes a unit for obtaining, from the stream storage unit, stream data that corresponds to the sequence information obtained by the sequence information obtaining unit, and for outputting the stream data in accordance with a sequence designated by the sequence information.

As the stream data stored in the stream storage unit is output, the output of stream data in accordance with the sequence information becomes smooth. Even when the stream data has large volume, there is not much burden on communication.

The stream output apparatus further includes a unit for determining whether stream data corresponding to sequence information is stored in the stream storage unit or not; and a unit for outputting information obtained from a prescribed information source, in response to a determination that the stream data corresponding to the sequence information is not stored in the stream storage unit.

When the stream data corresponding to the sequence information is not stored in the stream storage unit, information obtained from a prescribed information source is output. This prevents reproduction of the sequence information from being interrupted due to the unavailable stream data. Even when the stream data is unavailable, it is possible to present to the user information from the prescribed information source.

The unit for outputting information obtained from a prescribed information source may include a substitute information preparing unit for preparing information as a substitute for the stream data corresponding to the sequence information.

Since the information as a substitute for the stream data is prepared as the prescribed information source, the substitute information can be presented to the user when the stream data corresponding to the sequence information is unavailable.

The stream output apparatus further includes a stream information obtaining unit for obtaining attribute information of stream data; and a unit for generating a device address holding sequence information corresponding to the stream data, based on the attribute information of the stream data obtained by the stream information obtaining unit; wherein the sequence information obtaining unit includes a unit for obtaining sequence information corresponding to the stream data obtained by the stream information obtaining unit, based on the device address.

Based on the attribute information of the stream data, the device address for obtaining sequence information corresponding to the stream data is generated, and the sequence information can be obtained. Even when an address of the apparatus holding sequence information using a certain stream data is not known in advance, the sequence information can be obtained based on the attribute information of the stream data. This facilitates getting and using sequence information.

The sequencer unit may include a unit for combining and outputting an output of stream data and output of information obtained from an external device connected through a network, in accordance with the sequence information.

By the sequence information, it becomes possible to combine stream data output and the information obtained through the network and to output the same. Therefore, the sequence information enables combined reproduction of pieces of information on various media.

The sequence information includes information representing a reproduction sequence of stream data, and output control information representing a manner of combination at the time of output of information obtained from an external device and the stream data, and the stream output apparatus further includes a unit for outputting the output of the stream data and the information obtained from the external device in accordance with the manner of combination represented by the output control information.

The sequence information can designate in which combination the stream data output and the information obtained through the network are to be output. Therefore, the sequence information enables reproduction of pieces of information on various media in flexible combination.

The sequencer unit includes a searching unit for searching stream data ready for use with a reproduction sequence represented by the obtained sequence information, and a search stream selecting unit for selecting any of stream data obtained by the search by the searching unit.

After getting sequence information, stream data that meets the reproduction sequence is searched for by the searching unit. When there are a plurality of stream data found by the search, one of these is selected, and used at the time of reproduction of the stream data in accordance with the sequence information. Even when a plurality of stream data are prepared through various media in association with a common theme, one of these can be selected and reproduced.

The sequence information includes predetermined attribute information related to stream data used for the sequence information, and the attribute information is of such a nature that cannot specify stream data to be obtained solely by the attribute information; and the searching unit includes a unit for searching for stream data that matches the attribute information related to the stream data designated by the obtained sequence information.

After getting sequence information, using the attribute information related to the stream data used therein as a reference, the stream data matching the attribute information is searched for by the searching unit. It is possible to specify only the attribute of the stream data by one piece of sequence information, and to search for the stream data matching the attribute when the sequence is reproduced. Therefore, stream data can be reproduced in accordance with a prescribed sequence designated by the sequence information, even when the stream data is unspecified. Further, it is possible to output a plurality of different stream data in an edited form. When a plurality of stream data are prepared through various media in association with a common theme and information directly connecting these to the sequence information is not known in advance, the stream data suitable for reproduction of the sequence information can be searched for.

According to a second aspect, the present invention provides a computer readable recording medium storing a computer program controlling, when executed by a computer, the computer to operate as any of the stream output apparatuses described above.

According to a third aspect, the present invention provides a stream output method of outputting stream data in a stream output apparatus connected to a network, including the steps of: forming an address designating a device connected to the network; accessing the address to obtain sequence information of stream data; selecting stream data that matches the sequence information from locally stored stream data, based on the obtained sequence information; and outputting that portion of the selected stream data which is designated by the obtained sequence information, in accordance with the obtained sequence information.

An address designating a device connected through a network is generated, and from the address, the sequence information is obtained. Further, based on the sequence information, a stream data matching the sequence information is selected from locally stored stream data, and that portion of the thus selected stream data which is designated by the obtained sequence information is output in accordance with the sequence information. Portions of locally stored stream data can be output in accordance with the sequence designated by the sequence information saved in a device on a network, and the stream data can be reproduced in more versatile manner.

According to a fourth aspect, the present invention provides a stream output apparatus, including: a network portion for communication with a device connected through a network; a stream output portion for outputting stream data applied from a selected input; a timer portion for generating time information; a sequence information generating portion for generating sequence information related to stream data being currently output from the stream output portion, including time information representing time of output; and a sequence information transmitting portion for transmitting the sequence information generated by the sequence information generating portion to an external device.

In the stream output apparatus, the sequence information related to the stream data that is being output by the stream output portion can be generated including the time information of output, and the sequence information can be transmitted to an external apparatus. It is possible for the external apparatus to continuously output the stream data, that has been output by the stream output apparatus in accordance with the sequence information, based on the time information included in the sequence information.

According to a fifth aspect, the present invention provides an information providing apparatus for transmitting, to a terminal apparatus, sequence information designating a sequence for reproducing contents, including: a selecting unit for selecting sequence information in accordance with a predetermined procedure, in response to an occurrence of a prescribed event; a unit for determining a terminal apparatus to transmit the sequence information in relation to the event; and a transmitting unit for transmitting the sequence information selected by the selecting unit, to the terminal apparatus determined in relation to the event.

The sequence information designating a sequence related to reproduction of certain contents is selected in response to generation of a certain event, and transmitted to a prescribed terminal apparatus. Distribution of the sequence information can be activated on the side of the information providing apparatus. It is unnecessary for the prescribed terminal apparatus to make any action to get the sequence information.

The information providing apparatus may further include a search condition receiving unit for receiving a prescribed search condition from a terminal apparatus; a program information storage unit for storing program information; a sequence information storage unit for storing sequence information designating a sequence for reproducing contents; a first searching unit responsive to reception of a search condition by the search condition receiving unit from the terminal apparatus for searching the program information storage unit for a program that matches the search condition; a second searching unit for searching the sequence information storage unit for sequence information corresponding to a result of search by the searching unit; and a unit for transmitting a result of search including link information to the sequence information searched out by the second searching unit to the terminal apparatus that transmitted the search condition.

The search condition receiving unit receives a search condition transmitted from the terminal apparatus. The program information storage unit has program information stored in advance. A program matching the search condition received by the search condition receiving unit is searched for by the first search unit, and sequence information corresponding to the program is searched for by the second search unit. The result of searching including link information to the sequence information searched for by the second search unit is transmitted back to the terminal apparatus that transmitted the first search condition. The terminal apparatus can obtain a link to the sequence information for outputting the program matching the search condition, simply by transmitting the search condition to the information providing apparatus. Therefore, by the information providing apparatus in accordance with this aspect, the user using the terminal apparatus can obtain the desired sequence information easily. It is noted that the sequence information itself may be transmitted to the terminal apparatus, in place of the link to the sequence information.

According to a sixth aspect, the present invention provides an information providing apparatus for transmitting sequence information designating a sequence for reproducing contents, to a terminal apparatus through a network, including: a program information storage unit for storing program information including information at least identifying a program and broadcast time of the program; a sequence information storage unit for storing sequence information designating a sequence for reproducing contents; a time measuring unit for measuring current time; a unit for forming program table information dynamically changing with time, from the program information and the sequence information, with reference to current time and broadcast time of each program included in the program information, in response to a request from a terminal apparatus; and a unit for transmitting the program table information formed by the forming unit to the terminal apparatus that transmitted the request.

The forming unit forms, in response to the request from the terminal apparatus, the program table information that changes dynamically with time, based on the current time timed by the timer unit, the sequence information, and the program information stored in the program information storage unit. The program table information is transmitted to the terminal apparatus. As the program table information is appropriately created based on the time, sequence information and program information, it is possible for the user to always obtain the program table information in a satisfactory form, regardless of the time when the user transmitted the request.

The information providing apparatus may further include a unit, responsive to registration of sequence information in the sequence information storage unit, for forming the program table information at that time.

The contents of the program table information typically change as the sequence information is registered. Therefore, it is reasonable to re-configure the program table information when the sequence information is registered.

According to the seventh aspect, the present invention provides an information providing apparatus for transmitting sequence information designating a sequence for reproducing contents to a terminal apparatus through a network, including: a program information storage unit for storing program information including information at least identifying a program and broadcast time of the program; a sequence information storage unit for storing sequence information designating a sequence for reproducing contents; a unit for storing reservation information designating transmission of sequence information related to a specific program to a specific transmission destination; a unit responsive to registration of sequence information in the sequence information storage unit, for searching the unit for storing reservation information for a transmission destination that reserved transmission of the sequence information; and a unit for transmitting the sequence information registered in the sequence information storage unit, to the transmission destination searched out by the searching unit.

When sequence information related to a certain program is stored in the sequence information storage unit, a transmission destination that has reserved transmission of the sequence information is searched for, and the sequence information is transmitted to the searched out transmission destination. When the user reserves transmission of sequence information related to a desired program beforehand, the user could get the sequence information as soon as the sequence information is registered.

According to an eighth aspect, the present invention provides an information providing apparatus, including: a program information storage unit for storing program information; a sequence information storage unit for storing sequence information designating a sequence for reproducing contents, related to the program information stored in the program information storage unit; a transmission destination storage unit for storing, for each destination of information transmission, information identifying destination of information transmission and condition for searching for a program; a program searching unit for searching the transmission destination storage unit for a program that matches condition for searching a program; and a unit for transmitting the sequence information related to the program searched out by the program searching unit to a transmission destination stored in the transmission destination storage unit.

As the user has the condition for searching a desired program and the transmission destination stored in the transmission destination storage unit, the sequence information related to the program is transmitted to the transmission destination when the program matching the program search condition is found. Thus, the user can quickly obtain the sequence information related to the program satisfying the desired condition.

According to a ninth aspect, the present invention provides a computer readable recording medium storing a computer program controlling, when executed by a computer, the computer to operate as any of the information providing apparatuses described above.

As described above, according to the present invention, in the unit storing the stream data, the sequence information is obtained from an external device, and therefore, it becomes possible to easily output the digest and the like of the stream data. In a video distribution service using stream data, the sequence information related to the stream data may be created and provided by a service provider other than the user, so that a common user can always enjoy the digest (or appropriately edited stream data) of the stream data, simply by obtaining the sequence data.

Further, it is possible to access an apparatus of a different service provider by designating an address, and therefore, it is possible to select and obtain desired sequence information from pieces of sequence prepared by a plurality of service providers.

Further, the information on the Internet (web) and video images may be controlled by the sequence information. This enables display of video image digest with additional description obtained from the Internet, or display of video images with advertising information obtained from the Internet.

Further, the information of the stream data presently viewed by the user may be generated as sequence information and transmitted to another device. When a user watching certain stream data on a TV set wishes to watch the remaining part on a portable telephone, the information of the remaining part may be transmitted as sequence information from the TV set to the portable telephone. This is more effective when the stream data exists on the Internet. Similarly a service provider, not a user, may transmit the sequence information to the user and the user may watch the stream data in accordance with the sequence information. Thus, each user can quickly obtain necessary information by watching only the portions selected by the service provider, without watching the full stream data.

### BRIEF DESCRIPTION OF THE DRAWINGS

FIG. 1 schematically shows an overall configuration of the system in accordance with a first embodiment.

FIG. 2 schematically shows an overall operation of the system in accordance with the first embodiment.

FIG. 3 schematically shows a relation between the stream data and the sequence information.

FIG. 4 is a block diagram of the stream output apparatus in accordance with the first embodiment.

FIG. 5 schematically shows a relation between the program table and the sequence information.

FIG. 6 schematically shows exemplary sequence information in accordance with the first embodiment.

FIG. 7 is a block diagram of the sequence information providing apparatus in accordance with the first embodiment.

FIG. 8 is a block diagram of a computer implementing the stream output apparatus in accordance with the first embodiment.

FIG. 9 is a flow chart representing a control structure of a program realizing a stream output apparatus 50 in accordance with the first embodiment.

FIG. 10 is an illustration representing an exemplary sequence for displaying Internet information and stream video images in combination with each other.

FIG. 11 is a block diagram of a stream output apparatus 250 additionally having a function of displaying a stream and additional information in combination with each other.

FIG. 12 shows exemplary sequence information including information for combining additional information.

FIG. 13 shows an appearance of an exemplary remote controller operated by a user for outputting digest and main part of a program switched between each other.

FIG. 14 schematically shows the sequence displayed when the user presses various keys shown in FIG. 13.

FIG. 15 shows an exemplary program table when video images of one same event are broadcast at the same time on a plurality of broadcast channels.

FIG. 16 shows exemplary sequence information corresponding to the example shown in FIG. 15.

FIG. 17 is a flow chart representing an exemplary control structure of a program executing a process of searching and selecting a stream based on sequence information without broadcast channel designation.

FIG. 18 is a flow chart representing an example of the searching process executed in step 1206 shown in FIG. 17.

FIG. 19 schematically shows an overall structure of the system in accordance with a second embodiment.

FIG. 20 is a block diagram of a terminal apparatus 260 in accordance with the second embodiment.

FIG. 21 is a block diagram of the terminal apparatus 260 in accordance with the second embodiment.

FIG. 22 is a block diagram of a terminal apparatus 340 in accordance with a third embodiment.

FIG. 23 shows examples of stream information and address adding information used in the third embodiment.

FIG. 24 is a block diagram of a terminal apparatus 380 in accordance with a fourth embodiment.

FIG. 25 schematically shows examples of browser output and stream output in accordance with the fourth embodiment.

FIG. 26 is a flow chart representing a control structure of a program realizing terminal apparatus 380 in accordance with the fourth embodiment.

FIG. 27 shows exemplary sequence information in accordance with a fifth embodiment.

FIG. 28 shows an overall configuration of the system in accordance with a sixth embodiment.

FIG. 29 is a functional block diagram of a server apparatus in accordance with the sixth embodiment.

FIG. 30 is a functional block diagram of a sequence information transmission processing portion 518.

FIG. 31 is a functional block diagram of a search processing portion 516.

FIG. 32 is a functional block diagram of an accounting portion 520.

FIGS. 33 to 35 show examples of sequence information.

FIGS. 36 and 37 show examples of program table page.

FIG. 38 shows an example of an accounting destination table 584.

FIG. 39 is a hardware block diagram of a server apparatus 480.

FIG. 40 is a flow chart of a program executed by server apparatus 480.

FIG. 41 is a flow chart of a program table page processing.

FIG. 42 is a flow chart of a user contact information registering process.

FIG. 43 is a flow chart of a user designated program storing process.

FIG. 44 is a flow chart of a searching process.

FIG. 45 is a flow chart of a sequence information transmitting process.

FIG. 46 is a flow chart of an accounting process.

FIG. 47 is a flow chart showing an operation of the system in accordance with the sixth embodiment.

FIGS. 48 and 49 show examples of the system operation and image display of the system in accordance with the sixth embodiment.

FIG. 50 schematically shows a window image for searching, displayed on the terminal apparatus when the searching process is executed, in the system in accordance with the sixth embodiment.

FIG. 51 shows a result of searching.

### BEST MODES FOR CARRYING OUT THE INVENTION

### First Embodiment

In the following, the stream output apparatus in accordance with the first embodiment of the present invention will be described. It is assumed that the stream output apparatus described below is connected to a network. It is unnecessary for the stream output apparatus to be connected to the network, and the apparatus may be one that can obtain sequence information by using a storage medium such as a memory card. In the stream output apparatus described below, the stream data is mainly assumed to be television video images, and an apparatus as a destination of output from the stream output apparatus is assumed to be a TV monitor. The form of stream data, however, is not limited to television video images. Here, it is assumed that the apparatus as an output destination is suitable for displaying the contents of the stream data. By way of example, when the stream data is radio sound, the apparatus as the output destination may be a speaker or an earphone.

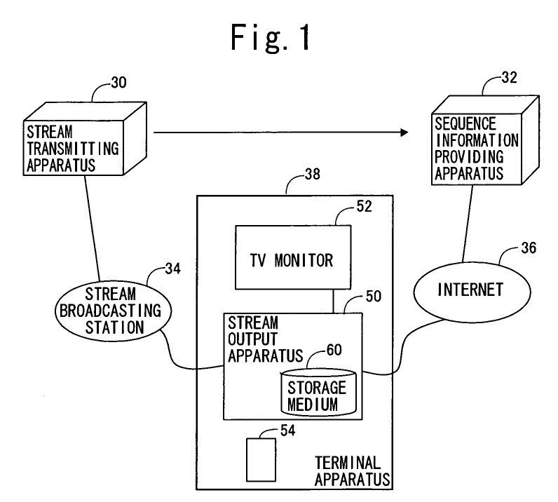

FIG. 1 schematically shows an overall system including the stream output apparatus in accordance with the present embodiment. Referring to FIG. 1, the system includes: a stream transmitting apparatus 30 transmitting a stream through a network or through a transmitting medium such as radio wave; a sequence information providing apparatus 32 having a function of storing sequence information related to the sequence as will be described later and distributing the sequence information as requested; a stream broadcast station 34 broadcasting the stream from stream transmitting apparatus 30 through stream transmission by terrestrial wave, satellite broadcast, cable broadcast or through the Internet; and a terminal apparatus 38 used by a user to watch the stream. Terminal apparatus 38 and sequence information providing apparatus 32 are both connected to the Internet.

Terminal apparatus 38 includes: a stream output apparatus 50 in accordance with the present embodiment that can receive a stream transmitted from stream transmitting apparatus 30 through stream broadcasting station 34 and can obtain arbitrary sequence information stored in sequence information providing apparatus 32 through the Internet; a TV monitor 52 for presenting the stream from stream output apparatus 50 and the sequence information obtained from sequence information providing apparatus 32 to the user; and a remote controller 54 for operating stream output apparatus 50.

Stream output apparatus 50 includes a storage medium 60 for storing the stream received through stream broadcasting station 34. Remote controller 54 is typically an infra-red remote controller or a portable telephone.

Detailed block diagram of stream output apparatus 50 can be seen from FIG. 4.

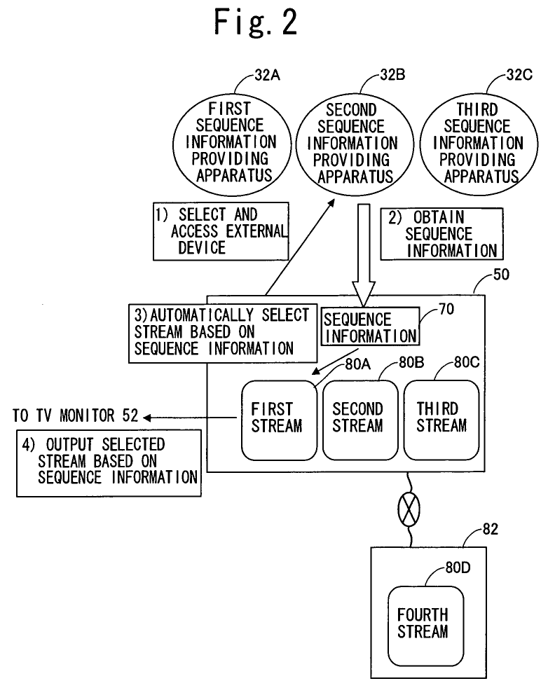

FIG. 2 schematically shows a typical procedure of operation. Here, it is assumed that stream output apparatus 50 has first stream 80A, second stream 80B and third stream 80C stored therein, and another device 82 that can communicate with stream output apparatus 50 through the network has a fourth stream 80D stored therein. It is assumed that sequence information is recorded in first, second and third sequence information providing apparatuses 32A, 32B and 32C that can communicate with stream output apparatus 50.

Based on a trigger by a user of stream output apparatus 50, one of sequence information providing apparatuses 32A, 32B and 32C that is designated by the user is accessed. Here, it is assumed that sequence providing apparatus 32B is designated. Next, sequence information 70 designated by the user is downloaded from sequence information providing apparatus 32 to stream output apparatus 50, and stored in a storage apparatus. A match between the information described in sequence information 70 and the stream that can be obtained by the device is found, and a stream necessary for performing stream reproduction in accordance with sequence information 70 is automatically selected from streams 80A to 80D. If necessary, the stream is obtained through the network. Then, part of or the entire stream is output to an external TV monitor (52) based on the sequence information.

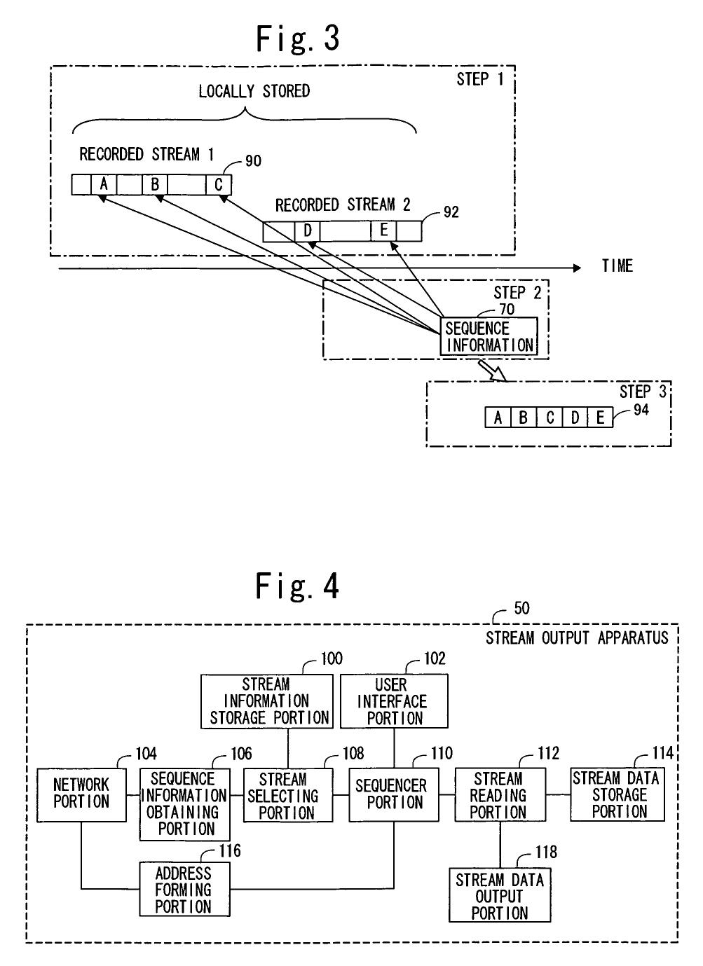

FIG. 3 is a schematic illustration showing a relation between the stream and the sequence. First, in step 1, stream output apparatus 50 locally records the stream transmitted from stream transmitting apparatus 30 shown in FIG. 1. Recording may be done at a time different from obtaining the sequence. When the stream is from a packaged medium such as a DVD or video images picked up by the user, the medium having the stream stored therein is set, and the stream is copied to a local storage medium as needed. At this time, stream output apparatus 50 simultaneously stores stream source information including media information, channel information or broadcast time information. The example of FIG. 3 shows that a stream 90 of channel 1 was obtained (recorded), and thereafter, a stream 92 of channel 2 was obtained. It is further assumed that stream 90 includes stream portions A, B and C, and stream 92 includes stream portions D and E.

In step 2, in response to a trigger by the user, sequence information 70 is obtained from sequence information providing apparatus 32B. Here, the sequence information is obtained after obtaining the stream.

In step 3, based on the obtained sequence information, parts of the recorded streams 90 and 92 are output continuously (94). By way of example, assume that stream 90 is a baseball game broadcast and stream 92 is a sports news program. Here, if sequence information 70 is created such that high-light scenes (portions A, B and C) of the baseball game and corresponding comments (D, E) of the sports news program are output continuously, the user could enjoy the streams in this order by selecting sequence information 70.

Specifically, according to the present embodiment, by using the sequence information obtained independent from the already recorded stream information, the streams can be edited at the time of reproduction. For instance, when streams of broadcast related to soccer game are stored, and digest sequence information created to selectively reproduce only the digest scenes of the game is obtained from a different digest information distributor, it becomes possible to reproduce a digest version of the soccer game.

There may be a plurality of providers providing such sequence information. When the server address of a provider is designated by the user side, the sequence information can be obtained from the server preferred by the user. The address to get the sequence information, or the sequence information itself may be distributed by an electronic mail. Alternatively, the sequence information recorded on a removable medium may be distributed by mail or the like. The provider may record the sequence information in a printable form of character strings or binary bar codes, and the printed object having the information printed may be distributed to the user. In that case, the user may read the sequence information from the printed object using an OCR (Optical Character Recognition) apparatus, a bar code reader or the like, and apply the read sequence information to stream output apparatus 50.

FIG. 4 is a block diagram of stream output apparatus in accordance with the present embodiment. Stream output apparatus 50 includes a stream information storage portion 100 storing the stream information. The stream information refers to information for identifying a stream recorded in stream output apparatus 50. For analogue broadcast, it includes information of broadcast channel, local information, recording start time, or recording end time. For digital broadcast, it generally includes collateral data, in addition to the information mentioned above. For example, it includes data to be transmitted together with the stream. It is possible to obtain information by accessing a network, different from the broadcast. For example, for convenience of reserved recording of broadcast program, a program table or the like distributed in electronic manner may be used. For packaged media such as DVD, a stream may be identified by identifying information unique to the package media.

Stream output apparatus 50 further includes: a network portion 104 communicating with other devices through a network such as the Internet; a sequence information obtaining portion 106 obtaining sequence information from a device connected through the network; a stream selecting portion 108 comparing stream information included in the sequence information with the stream information stored in stream information storage portion 100 and automatically selecting a stream; a sequencer portion 110 reading the stored stream information and controlling output in accordance with the obtained sequence information; a user interface portion 102 for the user to select sequence information or an external device for obtaining sequence information; and a stream reading portion 112 reading the stream in accordance with an instruction from sequencer portion 110.

Here, “reading” is to get data from a desired position of a desired stream, using time or time information as a key. By way of example, even in a device using a tape such as a VTR, data can be obtained from the desired position in this manner, if the position can be designated from the outside. The stream itself may be stored in a separate apparatus that can communicate through the network. For example, when IEEE (Institute of Electrical and Electronic Engineers) 1394 as digital bus technique and AV/C (Audio-Video/Control) command are used, fast forwarding using a time code in an apparatus connected through a bus is possible, and hence, similar operation can be realized. As for the stream stored in a random-accessible medium such as a DVD or a hard disk, possibly, the entire stream may be stored in a fragmented manner and position information thereof is managed in the form of a directory or a management file. In such a case, in order to obtain the stream of a time designated by the stream information, a process of converting from time to real position based on the management information is necessary. Any method may be used for this process. If the converting process takes time, it is desired that the conversion process of all the stream start positions should be completed before starting reproduction of the steams, so as to prevent interruption at the time of stream switching. Naturally, the stream may exist on the network and may include information of stream start time or start position information, allowing an access thereto.

Stream output apparatus 50 further includes a stream data storage portion 114 storing the stream. Each of the streams stored in stream data storage portion 114 is paired with stream information stored in stream information storage portion 100. Using the stream information, an actual stream data can be selected.

Stream output apparatus 50 further includes: a stream output portion 118 outputting a stream to a TV monitor 52; and an address forming portion 116 forming an address for designating an external device. The address is in most cases a URI (Uniform Resource Identifier) or URL (Uniform Resource Locator), but not limited thereto.

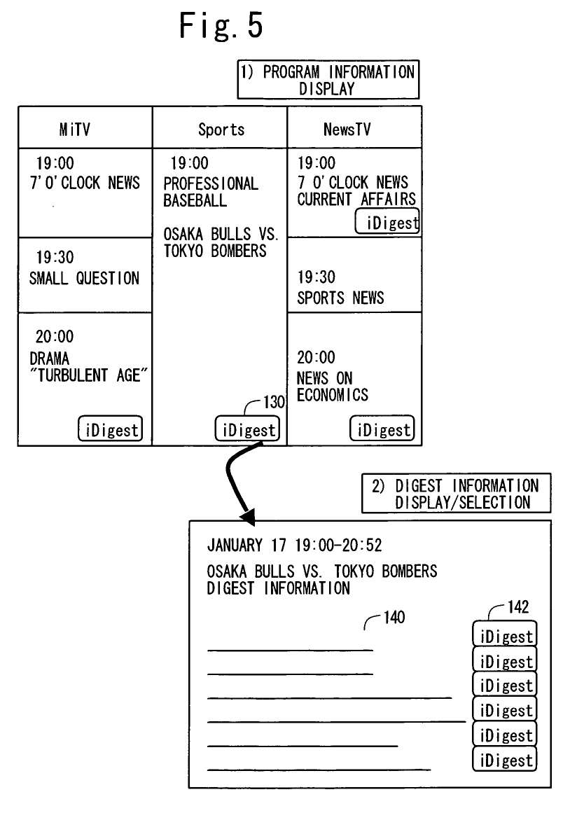

FIG. 5 shows an exemplary display given by stream output apparatus 50 in accordance with the present embodiment, for urging a user to select sequence information. In this example, the sequence information corresponds to an electronic program table. In this example, among a plurality of programs of a plurality of broadcast channels, those having sequence information to form digest versions are denoted by buttons 130 of “iDigest” on the program display, and this button provides linkage to the sequence information of the corresponding program.

When one presses button 130, an output such as shown at the lower portion of FIG. 5 appears. Assuming that there are a plurality of different pieces of sequence information for a program “professional baseball game: Osaka Bulls vs. Tokyo Bombers” shown at an upper portion of FIG. 5, an image allowing selection of any of the pieces of sequence information appears as shown at the lower portion of FIG. 5. This image includes indexes 140 representing contents of sequence information, and buttons 142 providing linkage to the sequence information, displayed as pairs. When one presses a button 142, the corresponding sequence information is obtained.

As the sequence information is provided in correspondence to the program information, digests of different programs can be obtained in a uniform manner. Further, even when there are a plurality of pieces of sequence information for one program, the plurality of pieces of sequence information can be provided in correspondence to the program, allowing selection of one piece of sequence information from among the plurality of pieces of sequence information, whereby various results of edition of one program can be presented to the user.

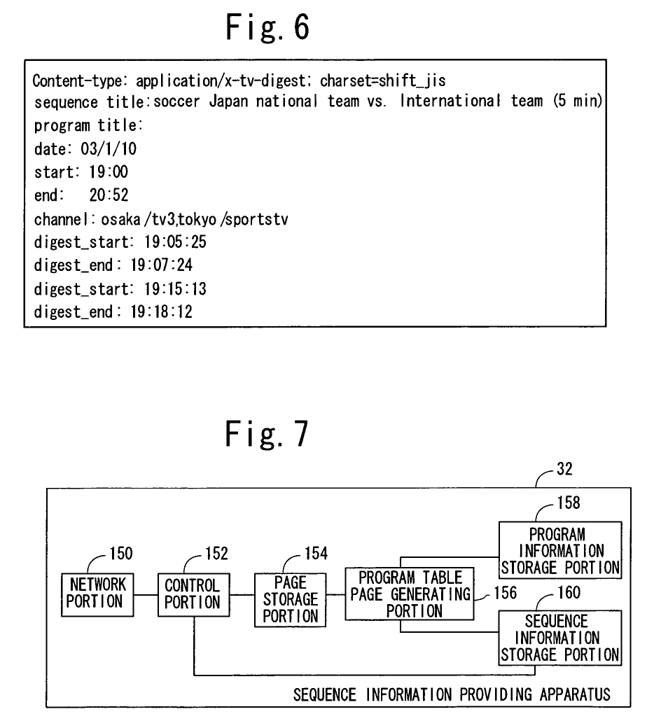

FIG. 6 shows exemplary sequence information. The sequence information is in the form of a text file, and has a file format that is provided in accordance with HTTP (Hyper Text Transfer Protocol) on the Internet. The first line represents contents type. Here, “application/x-tv-digest” is designated as the contents type, and “charset=shift_jis” represents that the character code of this file is in accordance with shift JIS.

The second line indicates a title of the sequence information. The title is given by the sequence information provider, which is referred to by the user when the user selects the sequence information. In this example shown here, the title represents that the sequence information is for reproducing a 5-minutes digest version of a soccer game “soccer Japan national team vs. International team.” In addition, other plurality of different pieces of sequence information for high-light scenes of specific players for 5 minutes, 10 minutes etc. may be prepared.

The term “program title” on the third line represents the title of the stream. Though it may be impossible to obtain a title when an analogue broadcast is recorded, a title can be obtained from digital broadcast or when a broadcast program is reserved using an electronic program table through the Internet or the like. The example shown in FIG. 6 assumes an analogue broadcast, and therefore, there is not a title.

The terms “date”, “start”, “end” and “channel” on the fourth to seventh lines denote the date of broadcast, start time of broadcast, end time and the channel of broadcast of the program corresponding to the sequence information, respectively. In this example, “osaka/tv3” and “tokyo/sportstv” are described as information representing the channel. The former represents that the program was broadcast by a broadcasting station denoted by tv3 in Osaka, while the latter represents that the program was broadcast by a broadcasting station sportstv in Tokyo.

Generally, different programs are broadcast in different regions. Broadcast stations may also vary. On the other hand, one same sequence information can be obtained from anywhere in the country through the Internet or the like. Therefore, when a user wishes to reproduce a digest version of a broadcast program recorded by the user based on a piece of sequence information, it is necessary to take into consideration the local difference of programs to prepare the sequence information. Local designation such as shown in this example allows accurate identification of the program that corresponds to the sequence information. Part of or all of the information is used for finding a match between the stream information stored in stream output apparatus 50 and sequence information 70.

Part of or all of such information is used for finding a match with the stream information (title, channel recording time and the like) stored on the side of the terminal and for selecting the stream described in the sequence information. Further, as there is a possibility that the broadcast time differ region by region, different times for different regions should preferably be described in parallel, and an appropriate one may be used on the terminal side.

Assuming global service, the time should be designated based on Greenwich Mean Time. For example, on the Internet, Japan local time is sometimes given as “Wed, 19, Feb 2003 19:09:23+0900” or the like. This means that the time is advanced by 9 hours from Greenwich Mean Time.

For a packaged medium, it is desired that a unique ID (identification information) representing the stream included in the package is included in the sequence information. For a packaged medium, broadcast time or channel need not be included.

Though not shown in FIG. 6, in the present embodiment, when a URL is described in the seventh line of “channel”, stream output apparatus 50 obtains, when outputting the stream by analyzing the sequence information, not the stream stored in stream output apparatus 50 but the stream data specified by the URL through the network. As the sequence information designating output of streams dispersed world-wide in a prescribed sequence is prepared, it becomes possible for the stream output apparatus 50 of the user to edit, form and output new contents. In this manner, by the apparatus of the present embodiment, the manner of combination of information obtained from an external device and the stream data at the time of output is held as sequence information, and in accordance with the manner of combination indicated by the sequence information, the output of stream data and the information obtained from an external device are output.

In FIG. 6, lines 8 and 9 and lines 10 and 11 respectively form pairs of “digest_start” and“digest_end”. These pairs each designate the start and end of portions to be reproduced of the stream data specified by the information of the previous lines, by the recording time or broadcast time of the stream data. There are a plurality of such pairs, and therefore, a plurality of scenes apart from each other in one stream data can be output continuously.

Here, “digest_start” is the information of a start point, which is indispensable, while “digest_end” is information of an end point, which may be unnecessary. When “digest_end” does not exist, a portion where the next “digest_start” appears or the last of the corresponding stream is regarded as the end point.

For the broadcast, typically, the time is designated by absolute time as in this example. For a packaged medium or the like that does not have the concept of absolute time, description should preferably be given in relative time from a prescribed reference time, such as the relative time from the start of the stream. Even for the stream to which the concept of absolute time is applicable such as in the case of broadcast, the time may be described in relative time similar to that for a packaged medium, if the stream can be uniquely identified by an ID or a name. When a program of the stream corresponds to broadcast program of the same contents broadcast at different time zones, such as in the case of rerun or time-shifted broadcast or on-demand type stream distribution, description in relative time is preferred.

In this manner, the sequence information basically includes information designating a stream and information designating stream start time and end time. Therefore, recording of sequence information does not require much amount of information. Therefore, it is possible to distribute a digest to the user with extremely small burden of communication, as compared with transmission/reception of the edited stream. Further, it is easy to store and save sequence information. Further, as the sequence information is simple information including the information designating the stream and the information designating the stream start time and end time, an individual user can easily form the sequence information.

As the sequence information can be created even by an individual user, it is possible that an individual creates and circulates the sequence information on the Internet. Therefore, the sequence information may include, as information to be referenced to when a user searches for desired sequence information, property information of the sequence information. The property information may include the title or category of the original program, author of the original program, copyright holder, or performer name. Based on such property information, a user can select sequence information on the Internet. Thus, it becomes easier to get desired sequence information. Further, some of the so-called search engines generally used on the Internet automatically indexes and registers words included in information circulated on the Internet. When the property information is registered by such a search engine, it becomes possible to search for the sequence information based on the registered property information.

Further, information related to each scene defined by the sequence information may be described. Stream output apparatus 50, receiving the sequence information, can organize the sequence information based on the property information. Accordingly, it becomes possible to present to the user which sequence information is available for a certain stream. Further, it is possible to detect and erase unnecessary sequence information when a certain stream is to be erased.

FIG. 7 is a block diagram of sequence information providing apparatus 32 shown in FIG. 1. Sequence information providing apparatus 32 includes a network portion 150 for communication with an external terminal (stream output apparatus 50 of FIG. 1), and a control portion 152 for overall control to meet a request from stream output apparatus 50. For a web page on the Internet, usually HTTP protocol is used. Typical example is that a received URL is interpreted and the designated contents are transmitted.

Sequence information providing apparatus 32 further includes a page storage portion 154 storing various contents. Page storage portion 154 further includes description of programs and the like, related to a program table page. Sequence information providing apparatus 32 further includes a program table page generating portion 156 generating a page of program table, and a program information storage portion 158 storing program information. The original data of the program table may be created in a format of, for example, spread sheet program, for easier handling. Eventually, however, the information must be transformed to a format (for example, in the case of a web page, a format described in HTML) to be transmitted as a program table to the terminal. Program information storage portion 158 stores the original data, and program table page generating portion 156 generates, from the original data, the data to be actually transmitted.

Sequence information providing apparatus 32 further includes a sequence information storage portion 160. The sequence information is created independent from the program table. The sequence information basically includes information specifying a program (channel, broadcast time and so on). Program table page generating portion 156 automatically generates, using the program information stored in program information storage portion 158 and the sequence information stored in sequence information storage portion 160, data having access information to the sequence information embedded in the program table. The generated result is as shown in FIG. 5. In the system of the present embodiment, the data is generated every time a transmission request is made. The data may be generated beforehand at a timing of change of the program information or sequence information. The data may be generated not automatically but manually.

As the data linking the program table to the sequence information is created on the side of the server and the data is transmitted in response to a request from a terminal as described above, it becomes possible for the client to select a digest corresponding to the program table. For a sports game or the like, the outcome of the game would be undesirably known if the user directly watches the news information. Such an undesirable exposure of the outcome before watching a digest can be prevented if sequence information is attached to the program information. In some apparatuses, reserved recording is done based on the program table, and therefore, it may be desirable to include a linkage to allow reserved recording of a program to be broadcast in the future, and to include a linkage to sequence information for the program broadcast in the past. Such an approach will be discussed in detail later, with reference to the sixth embodiment.

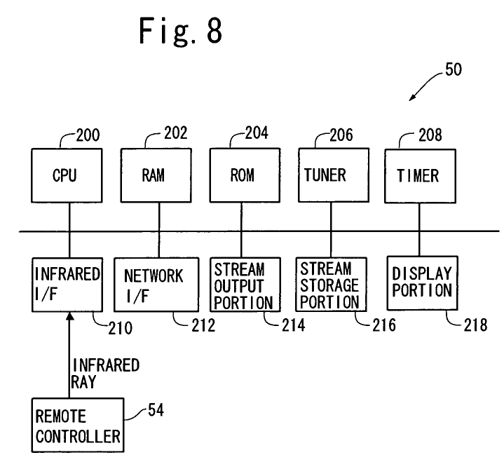

FIG. 8 is a block diagram of computer hardware when stream output apparatus 50 of the present invention is to be implemented by a computer. The computer includes: a central processing unit (CPU) 200 having an arithmetic processing unit therein for executing a process in accordance with a program; a random access memory (RAM) 202 for temporarily storing a program when the program is to be executed and for providing work area at the time when the program is executed; and a non-volatile read only memory (ROM) 204 for storing a program, fixed table and the like. It is desirable that the program and the like are rewritable through the network, for updating. Alternatively, a program may be recorded on a recording medium such as a CD-ROM, and the program may be written through a CD-ROM drive to ROM 204. The program may also be written to the hard disk.

The computer further includes: a tuner 206 for obtaining a stream; a timer 208 for obtaining time or counting time; an infra-red interface 210 receiving a signal from a remote-controller 54 operated by the user; a network interface 212 communicating with an external device; a stream output portion 214 outputting a stream in accordance with an instruction from CPU 200; and a stream storage portion 216 storing the stream. Though the stream may be stored in RAM 202, it generally requires a huge storage capacity, and therefore, it is often stored in a device having lower speed of operation but larger capacity such as a hard disk, as compared with the RAM.

The computer further includes a display portion 218 providing a display to the user. Display portion 218 is for displaying a plurality of pieces of sequence information to allow selection by the user, or for giving an error message.

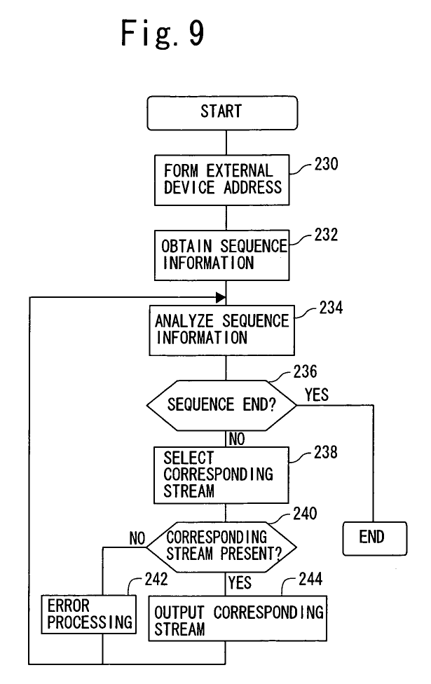

FIG. 9 is a flow chart showing a control structure of a program executed by CPU 200. The program includes a step 230 for forming an address of an external device to obtain sequence information. The address may be stored in advance in stream output apparatus 500, or input by the user, or obtained from another device through a link of web pages. In short, any method of designating an URL by a general browser may be adopted. As the user changes addresses, pieces of sequence information at various devices can be obtained, allowing selection from wide variety of sequence information.

The program further includes a step 232 for obtaining sequence information from the external device address created in step 230, a step 234 of analyzing the sequence information obtained in step 232, and a step 236 of determining whether all pieces of sequence information have been processed. If it is determined in step 236 that processing of all pieces of sequence information has been complete, the whole process ends. If it is determined that not all pieces of sequence information have been processed, the control proceeds to step 238.

In step 238, a process of selecting a stream designated by the sequence information in stream output apparatus 50 is performed. In the next step 240, whether the stream is stored in stream output apparatus 50 or not is determined. If it is stored, the control proceeds to step 244, and the stream is output in accordance with the sequence information. When the output ends, control returns to step 234, to analyze the next sequence information.

If it is determined in step 240 that the stream does not exist (or the time or time position designated by the sequence information does not exist), control proceeds to step 242. In step 242, an error processing is done. In the present embodiment, in step 242, a message that the stream does not exist, is output. Thereafter, control returns to step 234.

The operation of the system and stream output apparatus 500 in accordance with the present embodiment having such a structure is as described with reference to FIGS. 1 to 3 above. Because of such a structure, it is possible to easily output a digest of a stream or the like from stream output apparatus 500, by obtaining the sequence information of the stream from sequence information providing apparatus 32. By way of example, assume that service providers of sequence information prepare and provide sequence information of video images of soccer, baseball games or sumo programs. A common user can easily enjoy digests of soccer, baseball or sumo program at any time, simply by obtaining the sequence information thereof. Further, it is possible to connect to apparatuses of different service providers and to obtain sequence information by designating an address, and therefore, among pieces of sequence information created by a plurality of service providers, preferred one can be selected and obtained. Further, each service provider can edit and form a new stream by forming sequence information that connects different streams in a unique order.

Further, according to the system of the present embodiment, it becomes easier to combine and provide information on the Internet (mainly, information on the web page) and video images distributed through existing or new medium, in a unique manner in accordance with the sequence information. Therefore, by way of example, digest of video images can be combined with information provided on the Internet as additional description and displayed together, or information obtained from the Internet (such as advertising information) can be displayed between a series of video image sequences.

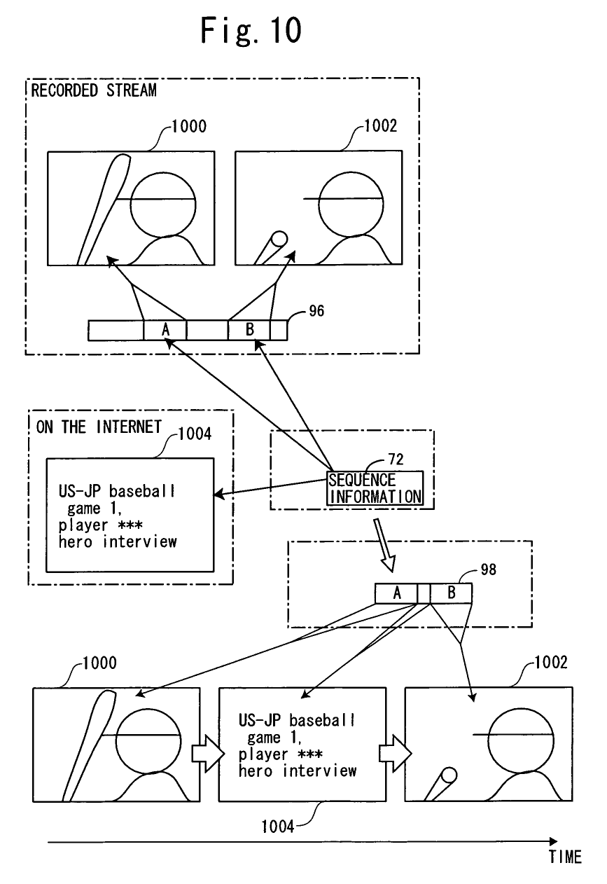

FIG. 10 is a schematic illustration showing an exemplary sequence for combining and displaying information on the Internet and the video images of the stream, in accordance with the sequence information. Referring to FIG. 10, in this example, stream 96 includes a stream portion A of video image 1000 and a stream portion B of video image 1002. Further, it is assumed that additional information 1004 describing stream portion B can be obtained from the Internet.

In a digest having stream portion A continued to stream portion B, the additional information 1004 can be combined. Here, an instruction to display for a prescribed time period the image of information 1004 as an independent scene between stream portions A and B is described in sequence information 72. In accordance with the instruction, the stream output apparatus outputs a stream 98 that displays information 1004 for the prescribed time period, before the output of stream portion B.

The description above relates to an example of sequential output of video image 1000, additional information 1004 and video image 1002. The output, however, is not limited to sequential output. By way of example, portions near the start or in the middle of video images 1000 and 1002 may be provided as still images, to be displayed in one image plane. In this case, it is preferred to add, as description of video image 1002, additional information 1004. Here correspondence between the still image and the motion picture must be established. For this purpose, the still image generated from the motion picture is time-stamped. This enables determination as to at what time point of the motion picture the output of still image should be started.

By such a manner of output, scenes included in video images 1000 and 1002 and additional information 1004 as description of video image 1002 can be output as one image plane, allowing the user to select an arbitrary one of these scenes. Thus, it becomes possible not only to enjoy the digest of the program from the start but also to start reproduction from the scene of video image 1002, for example, when the user selects “hero interview” indicated by additional information 1004.

An image plane including a still image corresponding to a selectable scene such as described above will be referred to as a “catalogue image” in the present specification. When the sequence information includes not only video images 1000 and 1002 but larger number of video images, it may be difficult to provide such catalogue display in one image plane. In that case, naturally, there may be a plurality of catalogue images.

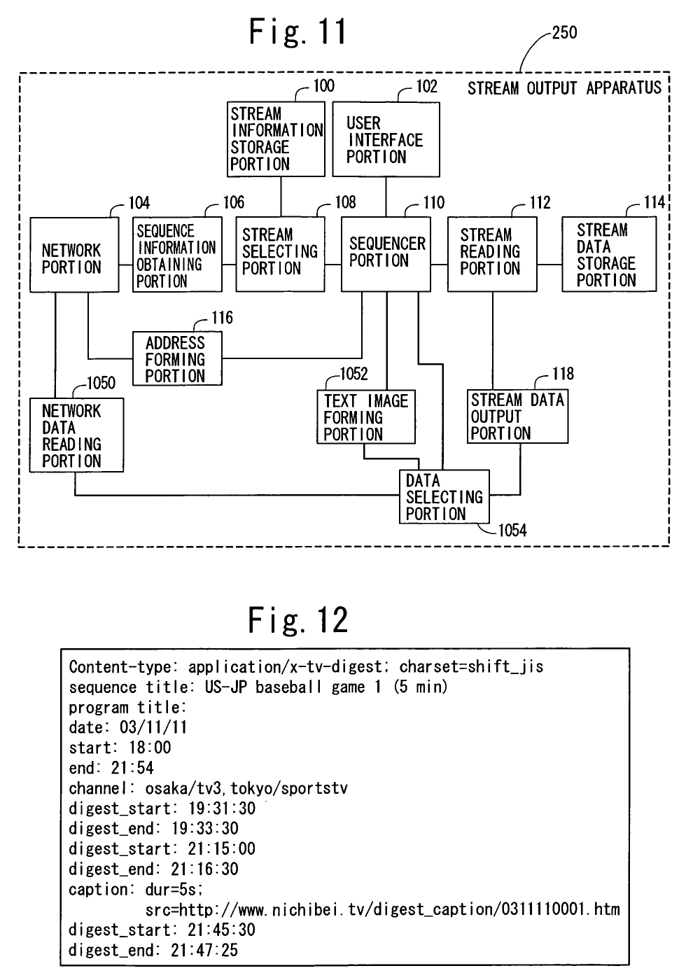

FIG. 11 is a block diagram of a stream output apparatus 250 additionally having a function of displaying a stream and additional information combined with each other, in accordance with the present invention. Referring to FIG. 11, stream output apparatus 250 is a modification of stream output apparatus 50 shown in FIG. 4, and includes, in addition to the configuration of stream output apparatus 50, a network data reading portion 1050 obtaining additional information from a device connected through the network portion and outputting the obtained information to TV monitor 52, and a text image forming portion 1052 obtaining, from the sequence information, a string of characters to be displayed in combination with the stream and outputting the obtained character string to TV monitor 52. Stream output apparatus 250 further includes, in addition to the configuration of stream output apparatus 50 shown in FIG. 4, a data switching portion 1054 switching between the output from network data reading portion 1050, output from text image forming portion 1052 and the stream output from stream output portion 118, in accordance with an instruction from sequencer portion 110.

FIG. 12 shows an example of sequence information 72 including information for combining the additional information. Referring to FIG. 12, the sequence information is described by the same method of description as the sequence information shown in FIG. 6. As compared with the one shown in FIG. 6, the sequence information newly includes an item “caption:” that designates display of additional information. Here, “dur=5s:” indicates that the time for displaying the additional information is “5 seconds”, and the description starting from “src=” designates the address of the additional information.

In the example shown in FIG. 12, following the paired descriptions “digest_start:21:15:00” and “digest_end:21:16:30”, there is the description “caption:”. Therefore, network data reading portion 1050 shown in FIG. 11 obtains information at the address designated by “src=http://nichibei.tv/digest_caption/0311110001.htm”, and forms a display image. Data selecting portion 1054 outputs the stream designated by the pair of “digest_start” and “digest_end” mentioned above, and thereafter, in accordance with an instruction from the sequencer portion, switches the output to the display image generated by network data reading portion 1050 for the time period (that is, 5 seconds) designated by the description “dur=5s;”. Data selecting portion 1054 switches the output for 5 seconds, and then switches to the output from stream output portion 118. Stream output portion 118 outputs a stream designated by the pair of descriptions “digest_start:21:45:30” and “digest_end:21:47:25”.

When the additional information is a string of characters and the like, the character string may be described in the sequence information. By way of example, as the method of describing the item “caption”, description “string=” representing the character string as the additional information may be defined. Assume that the additional information is a string of characters “US-JP baseball game 1, player *** hero interview,” the item will be described as “caption: dur=5s;string=‘US-JP baseball game 1, player *** hero interview.’38 Here, text image forming portion 1052 shown in FIG. 11 obtains the character string “US-JP baseball game 1, player *** hero interview” described as additional information with reference to the sequence information, and forms the display image of the character string. Data selecting portion 1054 switches the output in accordance with the instruction from sequencer portion 110. Consequently, the display image of the character string and the stream are displayed in a combined state.

It is possible to designate by the sequence information to display a specific scene of the stream and the additional information simultaneously. In such a case, data selecting portion 1054 may super-impose the additional information on, for example, the original video image of the stream. Alternatively, the additional information may be displayed at a specific area (for example, at a lower portion) of the output image, or it may be output by preparing an image separate from the original stream output image.

The additional information may be a still image, a different portion of the stream, or a motion picture, sound or the like prepared separate from the stream. Further, visual effect such as marquee or wipe may be added when the additional information is displayed.

Further, using descriptions in HTML or XML (eXtended Markup Language) or SMIL (Synchronized Multimedia Integration Language) used as technique handling various media with time-related operation, description designating font type, color of display, position of line feed or position of display and the like for displaying the character string of additional information may be added to the sequence information. Information to set visual effect such as the speed of the marquee in displaying the additional information may further be described in the sequence information.

Character image forming portion 1052 shown in FIG. 11 may provide the character string of additional information as voice reading, in place of the display on the screen. Alternatively, the display and voice output of character string may be provided simultaneously.

The pieces of information to be combined are not limited to those on the network servers. For instance, data may be distributed using VBI (Vertical Blanking Interval) of broadcasting wave, or using electronic mail. A format called MIME (Multipurpose Internet Mail Extension) is frequently used to attach various data to an electronic mail. It is possible to attach the information to be combined to the sequence information, using the MIME format. When the sequence information is transmitted/received by such method, the necessary information can be combined to the stream off-line, after getting the sequence information.

Further, the information to be combined may not be distributed but prepared on the side of stream output apparatus 250 beforehand, and the stream output apparatus 250 may combine the prepared information to the stream in accordance with an instruction of the sequence information. By way of example, stream output apparatus 250 may store information such as a standard expression or product logo mark in a readable removable storage medium or in a memory or auxiliary storage device of stream output apparatus 250, and the stored information may be read and combined in accordance with the designation by the sequence information. In that case, such stored information may be combined automatically, in accordance with a predetermined method. For example, during reproduction in accordance with a sequence, the video image of displayed stream may be output combined with the text “reproducing digest.”

Further, a description designating the speed of reproducing the stream may be included in the sequence information. Stream output apparatus 250 reproduces at a speed different from the originally intended speed of reproducing the stream. By way of example, when a negative speed of reproduction is designated, reverse reproduction may be started. Such designation makes it possible to prepare an educational program for coaching baseball, for example, from a professional baseball game digest, as it is possible to reproduce a stream in slow motion or to rewind and reproduce essential points in easily comprehensible manner. Information to add “comments” combined with the sequence would be more effective.

It is also possible to designate a position of display on a device or screen for displaying a video image of a certain scene and combined information, by the sequence information. Such designation allows reproduction of the stream and other information in the order as intended by the sequence designer. For instance, it becomes possible to point by an arrow a specific object in the output image, and to provide description of the object by text or voice.

In the present embodiment, stream output apparatuses 50 and 250 may be controlled by remote controller 54. The present invention, however, is not limited to such an embodiment. For instance, stream output apparatuses 50 and 250 may not be controlled by remote controller. Only some functions may be controlled by a remote controller. Further, while predetermined scenes are output, stream output apparatus 50 may be set uncontrollable by a remote controller. Further, a description designating a scene at which remote control is prohibited may be added to the sequence information, so that stream output apparatuses 50 and 250 may be made uncontrollable by the remote controller while the designated scene is being output. By such setting, it becomes possible to prevent a viewer from skipping a commercial message (hereinafter denoted by “CM”) or a portion promoting viewer awareness.

In the system of the present embodiment, stream transmitting apparatus 30 and sequence information providing apparatus 32 are separate, as shown in FIG. 1. The present invention, however, is not limited to such an embodiment. These apparatuses may be installed at the same place, or these may be implemented as one apparatus.

In the example shown in FIG. 3, it is assumed that streams 90 and 92 are of the same format. The streams, however, may not be of the same format or on the same medium. For example, the streams may come from different media, such as a tape and a DVD.

In the example shown in FIG. 3, the stream is obtained and thereafter the sequence information is obtained. The present invention, however, is not limited to such an order. For example, sequence information 70 may be obtained first, and the stream may be obtained. The sequence information and the stream may be obtained simultaneously. A plurality of obtaining methods may be appropriately used selectively.

A terminal that allows downloading of an entire program table may be set to download the entire sequence information. This realizes such a situation that when a stream is selected, the corresponding sequence has already been obtained.

Further, when recording is reserved (data of a program to be broadcast is downloaded), the sequence information may be transmitted to the user later. When the sequence information included in the message is analyzed on the receiving terminal, reproduction of a digest version becomes possible.

The stream may be transmitted over the Internet, or the sequence information may be transmitted as digital broadcast data. The stream transmitter may at the same time a sequence information provider.

Further, a stream including sequence information may be transmitted. By way of example, utilizing VBI in the broadcasting signal, the sequence information may be transmitted included in the stream. The sequence information included in the stream may not be the sequence information corresponding to the stream including the sequence information. For example, when a stream of live broadcast is broadcast, sequence information of the live broadcast may be transmitted included in a stream that is broadcast in the next time zone.

When broadcast of a certain program ends and the sequence information of the program is to be transmitted included in a stream of a different program, it is desirable that the expected time of transmission of the sequence information is noticed on a web page or on an electronic program table. In that case, the stream output apparatus may reserve the sequence information based on the notice, and may obtain the sequence information at the noticed time.

For instance, when a viewer finds the notice on the web page or electronic program table and reserves the sequence information, the stream output apparatus transmits information necessary for reservation to the sequence information providing apparatus. The sequence information providing apparatus may transmit the sequence information to the stream output apparatus by a mail or the like, as soon as the reserved sequence information is created. Alternatively, data indicating an expected time when the sequence information will be available may be attached to the web page or the electronic program table. When the viewer reserves the sequence information on the web page or the electronic program table, the stream output apparatus obtains the data of the expected time. When the time indicated by the obtained data comes, the stream output apparatus may get the sequence information from the sequence information providing apparatus.

In the example shown in FIG. 6 of the present embodiment, the sequence information is described as a text. The sequence information is not at all limited to the text format. Binary or any other form may be used, provided that the format is determined in advance and the contents can be distinguished by some means or other. When text format is used, the internal format may be described in more general language such as XML or SMIL.

Though an example in which the broadcast is recorded as stream data in stream output apparatus 50 has been described, similar concept is applicable to a packaged medium. For a packaged medium, in order to determine whether or not the obtained sequence information and the recorded stream match, a key of the packaged medium in the sequence information may be used to specify the stream. Stream output apparatus 50 can determine, by comparing a key in the sequence information and a key in the packaged medium, whether the two match or not. Even in that case, however, information specifying the reproduction sequence (sequence of start and end time of a portion to be reproduced, for example) is necessary.

The sequence information used in the system of the present embodiment has such a format as shown in FIG. 6. The sequence information format, however, is not limited to the one shown in FIG. 6. Any sequence information may be used, provided that it at least includes information designating a stream (such as broadcast channel information, broadcast time information) and the start time of stream.

In the example of sequence information shown in FIG. 6 of the present embodiment, in order to meet locally different services of broadcasting stations, information designating broadcasting station locally has been described in the channel information. The present invention, however, is not limited to such an embodiment. For example, of the information described in the sequence information, a portion that requires different designation region by region may be selectively read differently by the stream output apparatus. In that case, the stream output apparatus desirably stores a table for reading the sequence information differently for local users. The sequence information providing apparatus may obtain local information from the stream output apparatus, and based on the obtained information, it may change the sequence information locally and transmit the thus changed sequence information to the stream output apparatus. Alternatively, a server apparatus accessible from the Internet may be separately prepared, which receives the sequence information and the local information, reads the applied sequence information appropriately for the region represented by the received information based on a table for reading differently and returns the appropriately changed sequence information. When such a server apparatus is prepared, local designation can be done in a simple manner, when general users form and exchange pieces of sequence information.

The sequence information may include authentication information to prevent tampering. In that case, the sequence information providing apparatus and the stream output apparatus must additionally have the function of authentication. Further, the sequence information as a whole may be encrypted.

Further, an expiration date may be included in the sequence information. When the information expires, the stream output apparatus may get the new sequence information again to update the sequence.

In accordance with the present embodiment, the program table page generating portion 156 automatically generates, every time it receives a transmission request, data of the program table having access information to the sequence information embedded (as shown in FIG. 5). The present invention, however, is not limited to such an embodiment. For example, the data may be generated in advance at timing when the program information or sequence information is changed. Such data may be created not automatically but manually.

In the description of FIG. 8, an error output is given using display portion 218. The present invention, however, is not limited to such an embodiment. For example, stream output portion 214 may be used for error output.

In the present embodiment, according to the program having such a control structure as shown in FIG. 9, a message that the stream does not exist is output in step 242. The error processing in the present invention is not limited to such a method. Step 242 may simply be skipped without any operation, or a message that the stream does not exist may be given. Alternatively, information may be obtained from an external device, and the obtained information may be output.

Alternatively, a description or information designating a method of error processing may be added to the sequence information and the error processing may be done in step 242 in accordance with the method designated by the sequence information. For example, an address of another stream broadcasting station that provides the same stream as the selected one may be described. Alternatively, the sequence information may include description designating a stream or image as a substitute for the stream to be selected. Based on such description, the stream output apparatus may obtain and display a substitute stream or image for the stream to be selected. A plurality of designations for the error processing may be described.

In the embodiment above, when sequence information is selected, a corresponding stream is output. The present invention, however, is not limited to such an embodiment. In a situation where the sequence information is obtained in advance, a stream may be designated to select the corresponding sequence information. Such an approach is effective when the sequence information and the program table are obtained together, as will be described later. A stream may be selected when the user sets a medium such as a DVD or a VTR tape. In that case, the stream may not be selected from the sequence information, and when the sequence is selected, the currently set medium may be output simply in accordance with the sequence information, without checking the stream information.

In the embodiment above, when the user designates sequence information, a stream portion selected based on the sequence information is output. The present invention, however, is not limited to such an embodiment. The stream output apparatus stores the original stream as a whole that includes the stream portion to be selected based on the sequence information. Therefore, it is possible to switch the digest version output in accordance with the sequence information and the original stream (hereinafter the original stream will be referred to as “main version”) by a user operation. For example, a function or a button that allows, during reproduction of the digest version, continuous reproduction of the main version away from the digest version. By such a function, when a digest version of a news program including headlines only is obtained, the user may press the button at a headline portion of interest and the user can continuously watch the detailed version of the news.

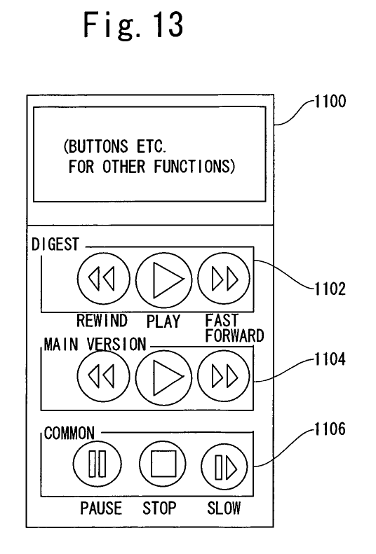

FIG. 13 shows an appearance of a remote controller operated by a user to switch output of a digest and the main version. Referring to FIG. 13, a remote controller 1100 includes a digest operation key 1102 for reproduction/fast-forward/rewind of the stream for digest output, a main version operation key 1104 for reproduction/fast-forward/rewind of the main version, and a key 1106 for operations common to the digest and main versions.

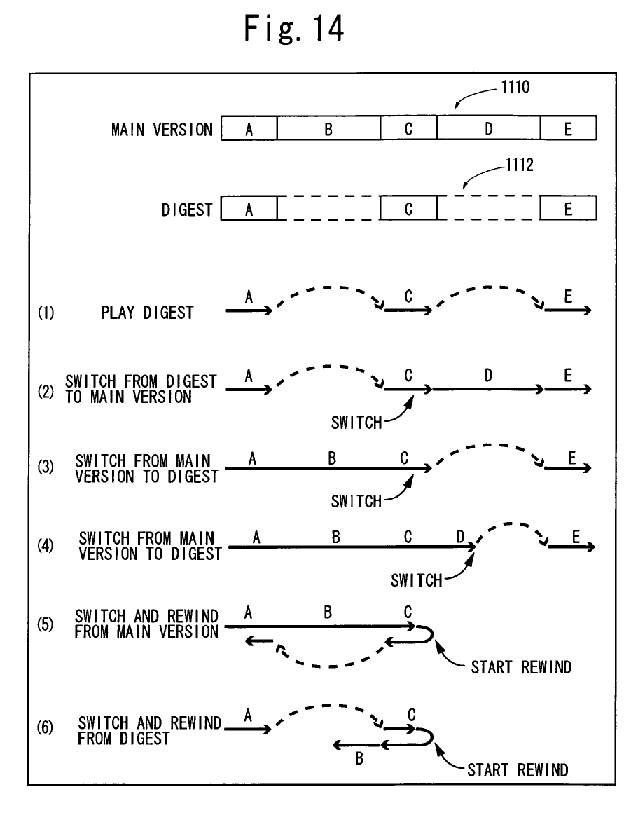

FIG. 14 schematically shows sequences displayed when the user presses respective keys shown in FIG. 13. Referring to FIG. 14, it is assumed that a stream 1110 including stream portions A, B, C and D is stored in the stream output apparatus. Further, it is assumed that the stream output apparatus has obtained sequence information to output a digest 1112 consisting of stream portions A, C and E of stream 1110.

The stream output apparatus outputs stream portion C of digest 1112 based on the sequence information, and when output of stream portion C ends, usually, the stream portion D is skipped and stream portion E is output (FIG. 14 (1)). When the reproduction button of main version operation key 1104 shown in FIG. 13 is pressed during reproduction of stream portion C, the output stream is switched from the digest to the main version. Therefore, when the output of stream portion C ends, the stream portion D is output continuously (FIG. 14 (2)).

When the reproduction button of digest operation key 1102 is pressed during output of stream portion C of the main version, the output of the stream output apparatus is switched from the main version to the digest. Therefore, when the output of stream portion C ends, stream portion D is skipped and stream portion E is output (FIG. 14 (3)).

Similarly, when the reproduction button of digest operation key 1102 is pressed during output of stream portion D of the main version, the output of stream output apparatus is switched from the main version to the digest. In the digest version, portion D is not output, and therefore, output of stream portion D ends at this time point, and output of stream portion E starts (FIG. 14 (4)).

When the rewind button of digest operation key 1102 is pressed during output of stream portion C of the main version, the output of stream output apparatus is switched from the main version to the digest. Therefore, the stream output apparatus rewinds from the currently output portion to the start of stream portion C, skips the stream portion B and resumes rewind from the last portion of stream portion A (FIG. 14 (5)).

When the rewind button of the main version operation button is pressed during digest-output of stream portion C, the output of stream output apparatus is switched from the digest to the main version. Therefore, the apparatus rewinds from the currently output portion to the start of stream portion C, and resumes rewind continuously from the last portion of stream portion B (FIG. 14 (6)).

By such a function, it is possible for a user watching a digest of home-run scene to go back and watch the main version fully from when the player stepped up to the plate. Here, the “reproduction” function may include slow reproduction, frame-by-frame reproduction or pause.

Further, assuming that a plurality of pieces of sequence information are obtained for one main version, such as sequence information of “3-minutes digest” and sequence information of “30-minutes digest” of one same baseball game, a function may further be provided that allows reproduction, fast-forward and rewind while switching among a plurality of digest versions. For such a function, a plurality of keys may be provided on the remote controller shown in FIG. 13, including a key for “main version” operation, a key for “first digest” operation and a key for “second digest” operation. Further, a selection key for selecting one among a plurality of switchable sequences may be provided on the remote controller. In that case, the user can switch sequence by using the selection key and the digest operation key or main version operation key.

A display indicating whether the reproduction is of “main version” or “digest” may be given. This allows the user to confirm whether he/she is watching the main version or digest, and hence, confusion in operation can be avoided.

In the present embodiment, the stream output apparatus outputs a selected stream on a TV monitor based on the sequence information and the TV monitor presents the same in the form of video images or sound, to the user. The present invention, however, is not limited to such an embodiment. The selected stream may be output to a recording apparatus that records video images or sound. The recording apparatus records the video image or sound output from the stream output apparatus on a hard disk in the apparatus or on a removable medium such as a tape or CD-R inserted to the recording apparatus. When the stream output apparatus outputs a series of streams selected in accordance with the sequence information to the recording apparatus, the recording apparatus records the same in accordance with the sequence. Thus, even when the original stream is recorded on a media such as a tape that sequentially records the information, the stream can be presented to the user as defined by the sequence without necessitating time and labor to find the intended portion, if the information newly recorded on the recording apparatus is reproduced.

If the video images or sound of the same contents to be reproduced are to be output, the video images or sound may be output in a data format different from that of the original stream.

By way of example, the bit rate of the video images or sound to be output can be set lower than the original stream. This makes it possible to view or hear the video images or sound formed by the sequence, on a portable terminal or a portable telephone that cannot reproduce the stream of high bit rate. Further, amount of data can be reduced, and therefore, this approach is effective for output to a device having limited storage capacity. Further, a signal that limits/prevents copying or tampering may be added at the time of output.

Further, it is also possible to form a sequence using a plurality of recorded streams. For example, utilizing sequence information, a digest consisting of error scenes only may be recorded from streams of daily baseball game broadcasts. Thus, even when the streams of original baseball game broadcasts are deleted, “error digest” may be formed by collecting error scenes recorded up to that point.

Though television broadcast has been assumed mainly as the stream in the present embodiment, the stream may be any data such as motion pictures, voices or combination thereof, provided that reproduction continuous in time is possible. When the stream is information including both sound and image as in the case of TV broadcast, the sequence information may include a description that separately designate video sequence and sound sequence.

In the stream output apparatus, or in the description of sequence information, “video image” and “sound” may be handled together or separately.

For example, when only the video images of a movie are used and the sound is obtained separately, it becomes possible to enjoy the movie as a dubbed version. When both the video images and the sound of the same stream of the movie are used and translation is given separately as a superpose, a superimposed version of the movie can be enjoyed.

It is often the case that a scene change of a video image is not timed with the voice of a commentator in a sport live-coverage. When the scenes are cut at such portions when creating the sequence information, at least one of video images and sound will be cut unnaturally. In such a situation, the video images and the sound may be temporarily handled separate from each other, so that each can be cut at convenient portions. Here, the longer one of the cut video image and sound defines the length of the scene, and thus, some effect or other contents may be added to the shorter one, to adjust the length.

When the output destination is a network-connected device, the destination device may reproduce instantly, without recording images or sound. By such an approach, it becomes possible to connect a portable terminal on the road to the stream output apparatus through a network, and to enjoy the stream output from the stream output apparatus through processing of sequence information on the portable terminal.

The sequence information used in the system of the present embodiment includes a description designating a broadcast channel, a server apparatus or the like that is a source providing the stream. The present invention, however, is not limited to such an embodiment. The designation of the stream need not be explicitly given in the sequence. What is necessary is that the stream can be specified in some manner, and it may be selected by the stream output apparatus determining compatibility, or user's selection may be requested at the time of output. When any of the streams broadcast in a specific time zone may be output, the sequence information may describe only the information designating time, such as the time of starting the stream.

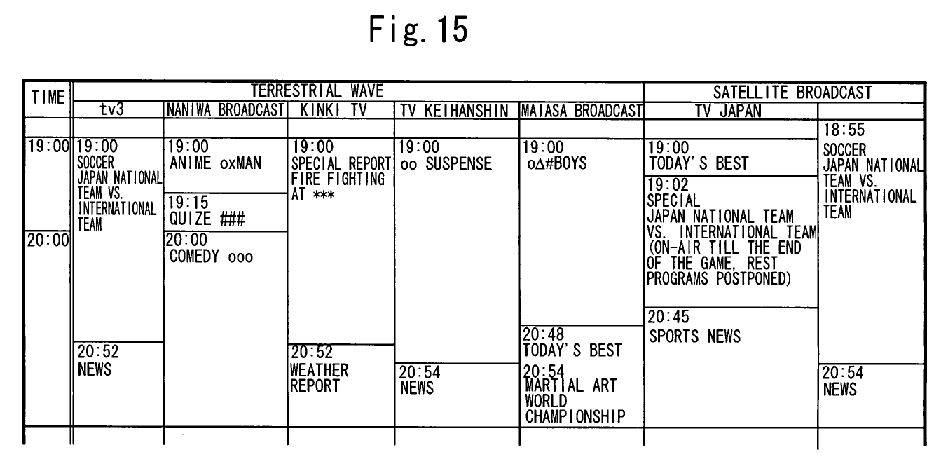

For instance, assume that programs such as shown in the program table of FIG. 15 were broadcast on Jan. 10, 2003 in a certain area. Referring to FIG. 15, in the time zone from about 19:00 to 20:50, programs of a soccer game “Japan national team vs. International team” were broadcast by broadcasting stations “tv3”, “TVJapan” and “New World Television”, as can be seen from the program table. Assume that the programs were all live-coverage, it follows that video image of one same event was broadcast at the same time. For example, if the scene of the “first goal” had been broadcast on 19:06 on “tv3”, then the scene of the “first goal” has also been broadcast in the program of “TVJapan” also at 19:06. Specifically, when the time of broadcast of the scene showing the “first goal” can be identified, the stream of the “first goal” portion can be picked up from any of these different streams provided from different broadcast stations.

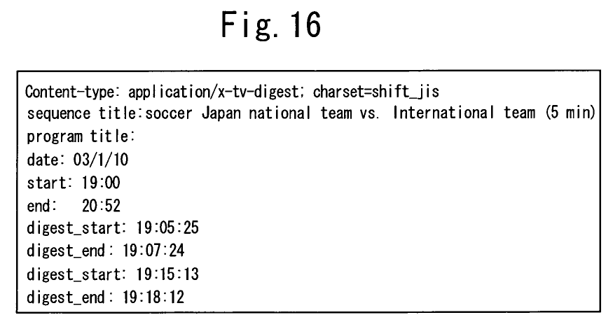

FIG. 16 shows an example of sequence information corresponding to such situation. The sequence information shown in FIG. 16 is similar to the sequence information shown in FIG. 6. The sequence information shown in FIG. 16 differs from that of FIG. 6 in the following point. Specifically, the sequence information shown in FIG. 16 does not include the item “channel:” that can be found on line 7 of the sequence information shown in FIG. 6. Thus, a digest of the stream provided in the time zone including the broadcast times described between lines 4 and 6 can be output regardless of the source providing the stream. Further, when there is the item “channel:” but the contents are blank, the operation may be the same as when the item “channel:” is absent as in the example of FIG. 16.

The sequence information shown in FIG. 16 is general sequence information not uniquely identifying the stream. In this case, the stream output apparatus may desirably include a function of searching a stream including the time zone identified by the time-designating description and a function of selecting a stream to be output from the searched-out streams.

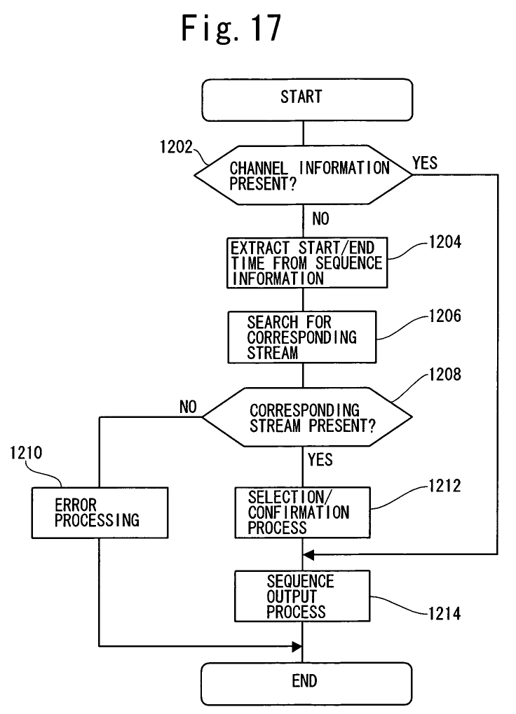

FIG. 17 is a flow chart showing an exemplary control structure of a program executing a process of searching and selecting a stream based on the sequence information without broadcasting station designation, such as the sequence information shown in FIG. 16. Referring to FIG. 17, the program is executed in place of steps 238 to 244 of the program shown in FIG. 9.

The program starts at step 1202, in which the sequence information is analyzed and whether there is any information designating a broadcast channel or not is determined. If the result of determination is YES, control proceeds to step 1214. If the result of determination is NO, control proceeds to step 1204.

In step 1204, from sequence information, program time information designating start time and end time of the program is extracted. In the next step 1206, the program time information extracted in step 1204 is compared and collated with record time information included in the stream information, to search for a stream. Control proceeds to step 1208. Details of the process in step 1206 will be described later.

In step 1208, the result of search in step 1206 is determined. If the result of search indicates existence of a stream that matches the searching condition, control proceeds to step 1212. If it indicates absence of any matching stream, control proceeds to step 1210, in which error processing takes place.

In step 1212, stream information of the searched stream is presented to the user, and an input by the user selecting a stream to be output as the digest is obtained. By this process, the stream is uniquely determined. In the next step 1214, based on the sequence information, the digest of the determined stream is output. When the output ends, this process is terminated. When the process of step 1210 ends, the control returns to step 234 of FIG. 9, and the above-described process is repeated until the end of the sequence information.

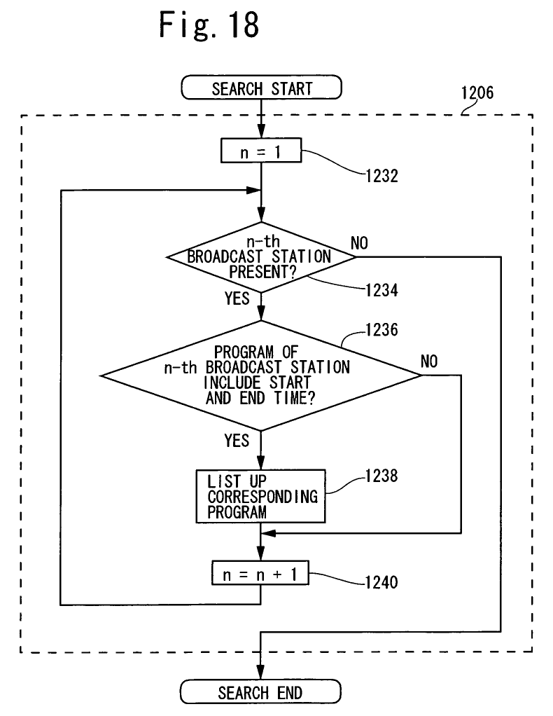

FIG. 18 is a flow chart representing an example of the searching process executed in step 1206 shown in FIG. 17. Referring to FIG. 18, in the searching process, a stream of a broadcast program is searched for station by station that presented the program. In this example, it is assumed that predetermined station numbers are allocated to broadcasting stations in the ascending order, starting from 1.

The process of steps 1206 starts at step 1232, where a value of counter n for searching for the stream information is initialized to 1. In the next step 1234, whether there is a broadcasting station of which number matches the value of counter n or not is determined. If the result of determination is YES, control proceeds to step 1236. If the result of determination is NO, the process of step 1206 ends.

In step 1236, the stream information of the program broadcast by the n-th station is compared with the program time information of the sequence information. Specifically, whether or not the program broadcast by the n-th broadcasting station includes a stream of which broadcast time include both the start time and end time designated by the program time information is determined. If there is a matching stream, control proceeds to step 1238. If there is no such stream, control proceeds to step 1240.

In step 1238, the stream information of the stream that matches the determination condition of step 1236 is listed up as the search result. The list is used in the process following step 1208 of the program shown in FIG. 17. In the next step 1240, 1 is added to the value of counter n. Then, control returns to step 1234.

Here, it is assumed that the streams are managed using a broadcasting station as a key. If it is not the case, what is necessary is simply to search for a program (stream) that partially or entirely includes the time zone defined by the start time and end time of the program.

In this manner, if general sequence information not uniquely designating a stream and a stream output apparatus having the additional function of searching a stream based on the sequence information are used, it becomes possible to output a plurality of different digest versions using one sequence information.

For instance, it might be possible that one same baseball game is broadcast as different programs through terrestrial waves and satellite broadcast, with camera works and comments different from each other. In that case, one sequence information may be used as the digest information of both broadcasts. Using one same sequence information, two digests, that is, a digest version from the stream of terrestrial broadcast and a digest version from the stream of satellite broadcast can be obtained.

Similarly, when one same sequence information is applied to a stream obtained by recording terrestrial broadcast and a video tape or photograph of the ball game actually picked up by an individual at a baseball stadium, two digests, that is, a digest of the terrestrial program and a digest of individually picked up video tape or photograph can be obtained.

When two or more digests of motion pictures are obtained using one sequence information as described above, it is desirable that these digests are synchronized to each other and reproduced on two image planes. This allows viewing scenes of the same play taken by different camera works simultaneously. When one of the digests is a photograph and the other is motion picture of video image or the like, it is desired that the photo is displayed when the reproduction time of the motion picture comes near to the time when the photo was taken. Thus, it becomes possible to enjoy both the motion picture and the photograph simultaneously.

Further, the searching process is not limited to the one illustrated in FIG. 18. For example, the stream may be searched using program time information, information of the broadcasting channel, or a key word in the stream information as a search condition. Such a searching function can also be used for the user to organize the streams stored in the stream output apparatus.

The sequence information shown in FIG. 16 is applicable not only to the streams of broadcast programs but also to streams other than the broadcast programs, such as the stream recorded by the user and stored in the stream output apparatus. For example, assume that a user actually enjoyed watching at the stadium and recorded on a video tape the soccer game “Japan national team vs. International team”, which was covered live in the program shown in FIG. 15. It follows that the video images picked up by the user are of the same event as the live coverage program shown in FIG. 15. Therefore, when the sequence information shown in FIG. 16 is applied to the video images, scenes similar to those obtained when the sequence information is applied to the live coverage can be reproduced as the digest of the video images. Further, when many participants of a sports event such as an athletic meeting at school took video recordings and the organizer distributes sequence information prepared based on the event schedule, it might be a good help for the participants to create video-album of the event from the video images picked up by themselves.

The process illustrated in FIGS. 17 and 18 may be utilized as an error processing when a digest is to be output based on sequence information having description of broadcasting station unmatched, such as when a sequence information designating a program by a key station is obtained while the stream of the program recorded on the stream output apparatus is the one broadcast by a local station.

### Second Embodiment

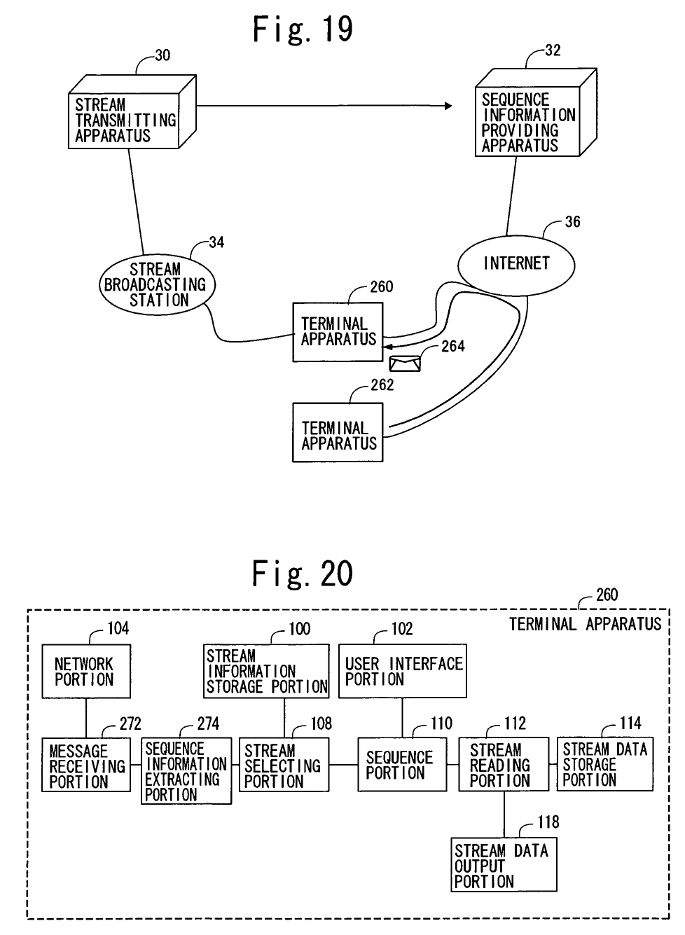

FIG. 19 is a block diagram showing an overall system of the second embodiment of the present invention. The system shown in FIG. 19 differs from the system of the first embodiment in that it additionally includes: a terminal apparatus 262, connected to a stream broadcasting station 34 and to the Internet 36, capable of outputting a stream and transmitting an electronic mail to a prescribed address through the Internet 36; and a terminal apparatus 260 capable of downloading sequence information from an external device designated by an electronic mail from terminal apparatus 262 and outputting the stream designated by the sequence information in accordance with the sequence information, in place of the stream output apparatus 50 shown in FIG. 1.

FIG. 20 is a block diagram of terminal apparatus 260 in accordance with the present embodiment. In FIG. 20, the same components as those of FIG. 4 are denoted by the same reference characters. They have the same names and functions. Therefore, detailed description thereof will not be repeated here. In the following figures, TV monitor 52 and remote controller 54 are not shown for simplicity of drawings. Therefore, in the following description, the terminal apparatus refers to the stream output apparatus.

Terminal apparatus 260 shown in FIG. 20 differs from stream output apparatus 50 shown in FIG. 4 in that the apparatus includes a message receiving portion 272 for receiving an electronic mail transmitted from the outside to the terminal apparatus 260 through network portion 104, and a sequence information extracting portion 274 for extracting the sequence information from the electronic mail received by message receiving portion 272 and applying the same to stream selecting portion 108.

The message received by message receiving portion 272 is an electronic mail or an instant message. Such a message is not transmitted from a predetermined device. When an electronic mail or instant message is sent to the apparatus as a destination from any transmitting side device, the message receiving portion 272 receives the message.

Generally, the message is described in a human-readable form, that is, in Japanese, English or other language. Sequence information extracting portion 274 is for extracting the sequence information from the message. A format called MIME is frequently used to attach various data to an electronic mail. In the present embodiment, the sequence information is also transmitted in the MIME format. In MIME, the sequence information or a name of an application handling the sequence information is added as a key, on the transmitting side. An example of the key is shown at the top of FIG. 6. In the example shown in FIG. 6, the key is “xtv-digest”. As the data boundary is also indicated simultaneously in this example, the data portion having the corresponding key in the portion segmented by the data boundary is extracted as the sequence information.

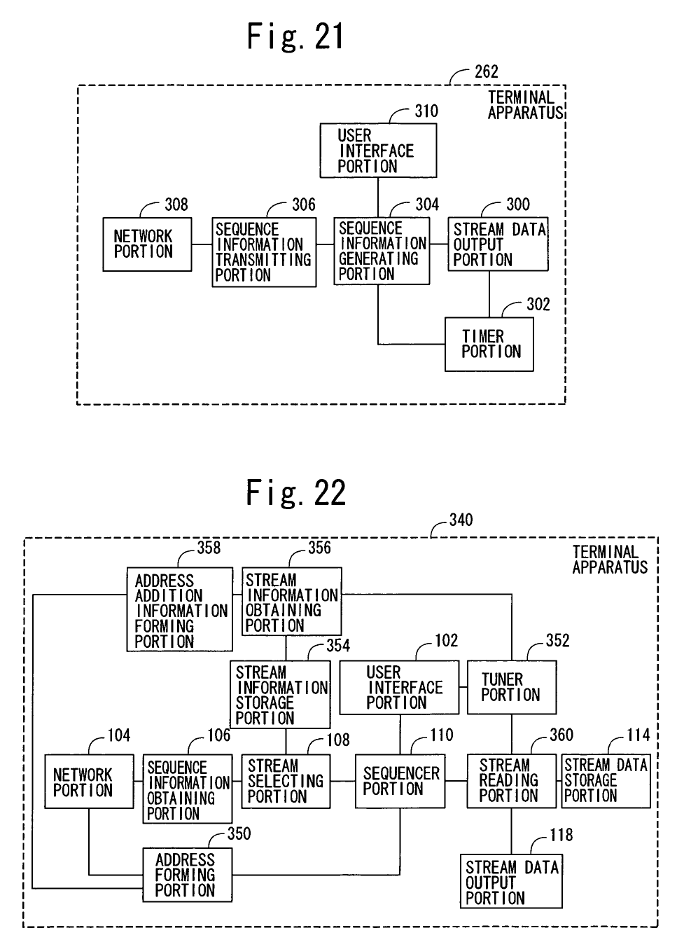

FIG. 21 shows, in a block diagram, the configuration of terminal apparatus 262. Referring to FIG. 21, terminal apparatus 262 includes a stream data output portion 300 outputting a recorded stream or received stream to an external device, and a timer portion 302 for specifying which position of the stream is being output at present. Timer portion 302 of the present embodiment is of an automatically calibrated type. For a recorded stream, timer portion 302 specifies a relative time (time on the medium) from the start of recording, and for a received stream, specifies the relative time from the start of the program.

Terminal apparatus 262 further includes a user interface portion 3120 for an interaction with the user, and a sequence information generating portion 304 for generating stream information output when designated by the user through user interface portion 310. Here, for a broadcast, sequence information generating portion 304 creates and outputs stream information having channel information and time information described and information of output time added. Such information is created as the sequence information, in the form of, for example, FIG. 6. Here, the sequence information does not both include digest_start and digest_end shown in FIG. 6, but includes the time or time point representing the current position as an item of digest_start. This corresponds to a case where the digest information designating continuous reproduction from the current position is to be created.

Terminal apparatus 262 further includes a network portion 308 communicating with a device connected through the network, and a sequence information transmitting portion 306 transmitting the information generated by sequence information generating portion 304 to a prescribed device through network portion 308. In the present embodiment, sequence information transmitting portion 306 and network portion 308 transmit the sequence information as an attachment to the electronic mail. The transmission destination is designated by the user through user interface portion 310. For example, an electronic mail with sequence information attached is transmitted through sequence information transmitting portion 306, network portion 308 and the Internet 36 to terminal apparatus 260.

Terminal apparatus 260 receives the electronic mail, extracts the sequence information from the attached file, analyzes the same, and reproduces the stream in accordance with the sequence information, in the similar manner as in the first embodiment.

In the system in accordance with the second embodiment, the following operation is possible. Specifically, assume that a user viewing a stream using terminal apparatus 262 transmits, in the middle of the stream, the information of the stream that is being output at that time point as the sequence information, attached to an electronic mail, to terminal apparatus 260. Terminal apparatus 260 receives the electronic mail through network portion 104 and message receiving portion 272. Sequence information extracting portion 274 extracts the sequence information from the file attached to the electronic mail, and applies the information to stream selecting portion 108. Stream selecting portion 108 stores the sequence information in stream information storage portion 100.

Thereafter, the user calls the sequence information stored in stream information storage portion 100, using user interface portion 102, and views the stream.

By using terminal apparatuses 262 and 260 in this manner, it becomes possible for the user to view the stream that has been displayed on terminal apparatus 262 on terminal apparatus 260 in accordance with the stream information. As the time information as to when viewing of the stream has been interrupted is included in the sequence information, the user using terminal apparatus 260 can reproduce the remaining part of the stream from that time point.

As described above, in terminal apparatus 260 in accordance with the second embodiment, it is possible to obtain sequence information from an electronic mail or an instant message transmitted from an unspecified external device, and to edit a stream using the information. For example, it is possible from the service side to transmit the sequence information, designating the user. Therefore, it is possible for a service provider to transmit uniquely edited sequence information to specific subscribers, and the subscribers can view the provided stream (digest and the like) in accordance with the sequence information.

Further, using terminal apparatus 262 of the present embodiment, it is possible to transmit sequence information created by terminal apparatus 262 to another terminal apparatus 260 by an electronic mail, and to reproduce the remaining part of the stream on terminal apparatus 260, continuously from the portion that has been reproduced on terminal 262. By way of example, when the sequence information is transmitted from the terminal apparatus at home to a portable telephone by an electronic mail, it becomes possible to view the remaining part of the stream on the road using the portable telephone. In that case, it is generally necessary that the stream having lower bit rate different from that reproduced on terminal apparatus 260 is reproduced on the portable telephone. It is unnecessary that the stream itself is of the identical data (same data format), and what is necessary is that the contents of the stream are the same.

In the present embodiment, the sequence information is transmitted in MIME. The present invention, however, is not limited to the use of MIME. For instance, the stream information may be described in XML or other form. The sequence information may be directly described as the main body of the message.

In the present embodiment, the sequence information transmitted from terminal apparatus 262 to terminal apparatus 260 is the time of one point of the stream that is being reproduced. The present invention, however, is not limited to such an embodiment. For example, the user may transmit period information consisting of the first and last time of a stream as the sequence information. Alternatively, a plurality of methods such as described above may be mixed.

In the present embodiment, timer portion 302 specifies relative time of reproduction. The present invention, however, is not limited to such an embodiment. For example, time portion 302 may specify an absolute time (possibly, time based on the Greenwich Mean Time) to identify the broadcast time.

### Third Embodiment

FIG. 22 is a block diagram of a terminal apparatus 340 in accordance with the third embodiment of the present invention. Terminal apparatus 340 corresponds to stream output apparatus 50 in the system in accordance with the first embodiment and to terminal apparatus 260 in accordance with the second embodiment. It is noted, however, that the apparatus enables getting the sequence information simply by designating a stream, by adding sequence information to the stream or by using a sort of electronic program table of the streams.

In FIG. 22, components same as those shown in FIG. 4 are denoted by the same reference characters and same names. They have the same functions. Therefore, detailed description thereof will not be repeated here.

Terminal apparatus 340 shown in FIG. 22 differs from stream output apparatus 50 shown in FIG. 4 in that it additionally includes: a tuner portion 352 for obtaining a stream; a stream information obtaining portion 356 for obtaining stream information of the stream obtained by tuner portion 352; and an address addition information forming portion 358 for forming an address to access the sequence information from the stream. The apparatuses differ also in that, as tuner portion 352 is added, a stream reading portion 360 is provided that additionally has a function of receiving the stream from tuner portion 352 and outputting the same to stream data output portion 118 in place of stream reading portion 112; as stream information obtaining portion 356 is added, a stream information storage portion 354 is provided that additionally has a function of receiving and storing stream information from stream information obtaining portion 356, in place of stream information storage portion 100 shown in FIG. 4; and an address forming portion 350 for forming an address to obtain the sequence information from an output of address addition information forming portion 358 and from an output of network portion 104 is provided in place of address forming portion 116 of FIG. 4.

Tuner portion 352 is, in the present embodiment, a TV tuner that receives a broadcasting service. Stream information obtaining portion 356 obtains, when stream data is received by tuner portion 352, the stream information thereof. The stream information obtained by stream information obtaining portion 356 is stored in stream information storage portion 354. Stream selecting portion 108 compares the stream information and the sequence information obtained by sequence information obtaining portion 106.

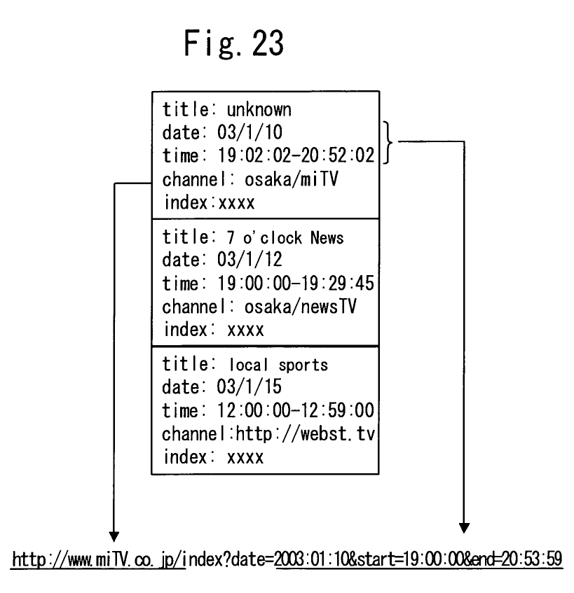

Address addition information forming portion 358 is to make it easier, when the recorded stream is designated by a user instruction, to obtain the corresponding sequence information. FIG. 23 shows an example of forming the address addition information from the stream information.

FIG. 23 shows three different pieces of stream information. The three pieces of stream information are shown at the upper, middle and lower boxes of FIG. 23. Each stream includes information of title, date, channel and index.

For example, the upper box represents a stream having an unknown title, broadcast from an Osaka station miTV from 19:02:02 on Jan. 10, 2003. The information described as an index is necessary for an access to the stored stream. In the example of FIG. 23, indexes are all described as “xxxx”. The actual index information holds information indicating the head position of the stream. The middle box contains information related to a stream of a program “7 o'clock News”, and the lower box contains information related to a stream of local sports. In the example of the lower box, a URL is described for the item “channel”, and it can be known that the stream is stored in an external device.

Address addition information forming portion 358 forms an URL for an access to the sequence information, based on such stream information. By way of example, based on the channel information, date and time of broadcast, address addition information to be added to the URL for accessing the web site of the corresponding channel is formed, as shown in FIG. 23. By adding the address addition information to the URL (for the stream information in the upper box of FIG. 23, “http://www.miTV.co.jp”) formed by address forming portion 350, an address for obtaining the sequence information can be obtained. In the URL at the lowest portion of FIG. 23, the portion following “?” is the string of address addition information corresponding to the stream information in the uppermost box. By this URL, the sequence information corresponding to the original stream can be obtained.

By way of example, when the broadcasting station miTV creates sequence information of a program broadcast by the station itself and posts the sequence information on its web site, it is possible for the user to directly obtain the sequence information by designating the stream. In that case, when the address addition information is created from the stream information, as described at the lowermost portion of FIG. 23, it becomes possible to obtain the sequence information related to the stream, simply by designating the stream.

Assume that the stream is a soccer program. There may possibly be a number of pieces of sequence information corresponding to the broadcast of about 2 hours, such as sequence information for forming a 5-minutes digest, 30-minutes digest, and high-light scenes of Japan national team. All these pieces are obtained in accordance with the present embodiment.

In this manner, as the address is formed based on the information obtained from the recorded stream, it becomes easier to obtain a sequence appropriate for the stream designated by the user.

Sequencer portion 110 has a timer and controls the sequence on the timer basis. Where the portion to be reproduced may be designated by an absolute time as in the example of FIG. 6, time difference between an external device and the apparatus would result in time error in the sequence output. Therefore, it is desired that the sequencer portion has a timer that is automatically calibrated. The method of calibration may use reference time tone transmitted by radio wave, or may use a time calibration protocol on the Internet.

Tuner portion 352 in the third embodiment is a TV tuner. The present invention, however, is not limited to such an embodiment. For example, tuner 352 may be one that obtains a stream from the Internet. In place of tuner portion 352, a portion that can select one among a number of streams by switching packaged media including CDs and DVDs may be provided. A packaged medium such as a DVD allows random access to get a stream. Therefore, stream reading portion 360 and tuner portion 352 shown in FIG. 22 can be regarded as an integrated body. For an analogue tuner, data is generally recorded in an encoded, compressed form in accordance with MPEG (Motion Picture Experts Group) 2 or the like. Any data format such as MPEG2, MPEG4, MP3 or analogue format may be used, as long as it is time-sequential.

In the present embodiment, when the stream data is obtained by tuner portion 352, stream information storage portion 356 obtains and stores the stream information. The present invention, however, is not limited to such an embodiment. When recording of a broadcast is reserved using an electronic program table distributed on the Internet, for example, the stream information may be obtained using the information of the program table. For packaged media such as DVD, identification information (ID) unique to the packaged media may be used.

In the present embodiment, when there are a plurality of pieces of information for one program, all these pieces are obtained. Before getting these pieces of information, a user may select a desired one. Further, in the example above, all information is embedded in the address. The present invention, however, is not limited to such an embodiment. Any form may be used, provided that the device providing the sequence information connected to the network can specify the stream.

### Fourth Embodiment

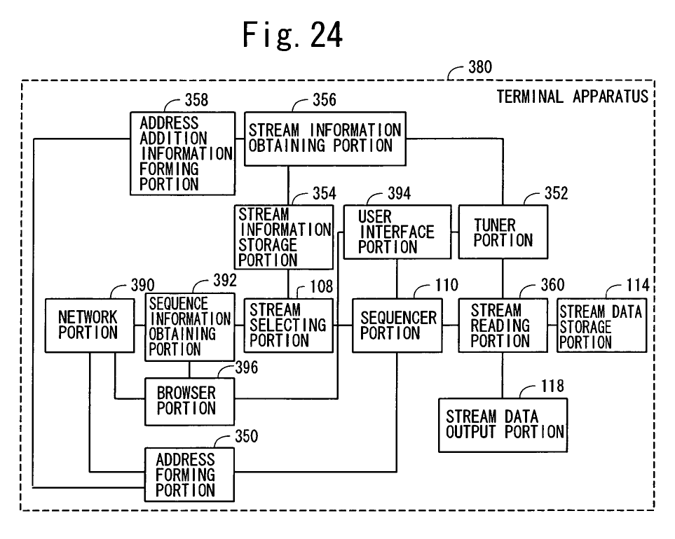

FIG. 24 is a block diagram of a terminal apparatus 380 in accordance with a fourth embodiment of the present invention. Referring to FIG. 24, terminal apparatus 380 includes, in addition to the configuration of terminal apparatus 340 shown in FIG. 22, a browser portion 396 obtaining information from an external device connected through a network and forming data to be displayed. Browser portion 396 is typically an Internet browser that obtains web data described in HTML and creates information to be displayed. It may be a browser portion that displays data transmitted to VBI or data transmitted by data-broadcast of digital broadcast. As the browser portion 396 is additionally provided, terminal apparatus 380 differs from terminal apparatus 340 in that in place of network portion 104, sequence information obtaining portion 106 and user interface portion 102 shown in FIG. 22, it includes a network portion 390, sequence information obtaining portion 392 and a user interface portion 394 that are connected to browser portion 396. Typically, browser portion 396 has, similar to a common Internet browser, a system for processing browser language, in addition to the simple function of creating the display data.

Based on the web data received by network portion 390, the display data created at browser portion 396 is output through stream data output portion 118. In the present embodiment, stream data output portion 118 outputs video images to the TV monitor. Therefore, stream data output portion 118 converts the display data to analogue video signals and outputs the signals.

Provision of a browser enables selection of sequence information from the browser. By way of example, when a user is viewing a site providing sports news on the Internet and obtains sequence information linked from the news, it is possible to provide an output in accordance with the sequence information, from a stream locally stored in correspondence to the sequence information.

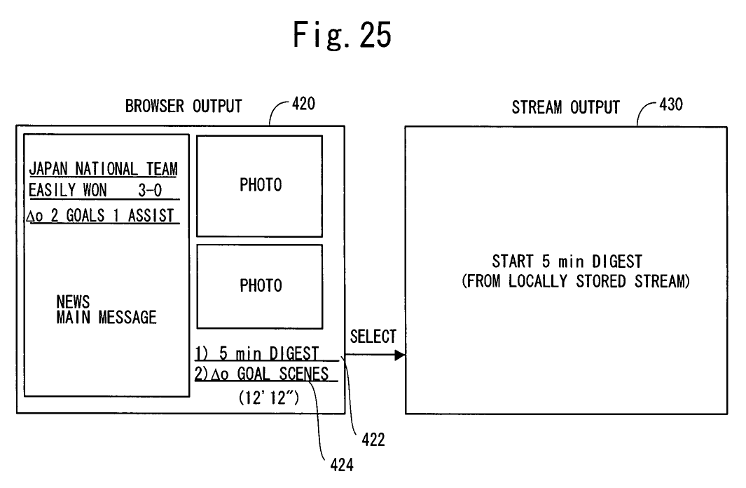

FIG. 25 shows an example of display. The left side of FIG. 25 shows an exemplary browser output. In this example, the browser displays a page 420 of sports news obtained from the Internet. On the page, there are portions 422 and 424 describing “5-minutes digest” and “Δo goal scenes”, respectively. These portions are sequence information designating portions, and at these portions there are links to the respective pieces of sequence information in the form of URLs with address addition information. When the user selects these portions, the sequence information can be obtained in the similar manner as browsing a web page using a typical browser. The sequence information may be held by a device different from the device holding the information of the sports news.

When the user selects the portion 422 of “5-minutes digest”, the output is switched from the browser output to a stream output 430 that is locally stored, and the stream is output in accordance with the sequence information.

By the configuration described above, it becomes possible to obtain information such as the news from the Internet and to obtain related motion picture from the stream that has been stored in advance in stream information storage portion 354 through tuner portion 352.

In the present embodiment, the sequence information is downloaded using a link. The present invention, however, is not limited to such an embodiment. For instance, when the sequence information is simple, the sequence information may be directly embedded in the URL, in place of providing a link to the sequence information. Specifically, “vtr://localhost/?area=Osaka&sorcech=8ch&starttime=20030630210100&en dtime=20030630210420” is described as an URL. This description instructs that from the contents already recorded on the VTR, a portion broadcast from Jun. 30, 2003, 21:01:00 to 21:04:20 at channel 8 in Osaka be reproduced.

When information corresponding to sequence information is displayed (output) as represented by portions 422 and 424 describing “5-minutes digest” and the like in FIG. 25, it is desired to confirm whether the stream included in the sequence information can be accessed from the present apparatus (that is, whether the output in accordance with the sequence information is possible), and to show the result of confirmation on the browser. It is preferred that, through such a process, when the stream can actually be output in accordance with the sequence information corresponding to the information, the information corresponding to the sequence information is displayed in a selectable manner, and when the corresponding stream is unavailable and the output is impossible, the information corresponding to the sequence information is displayed in a non-selectable manner. By way of example, when selection is impossible, the display may be given in a dimmed color.

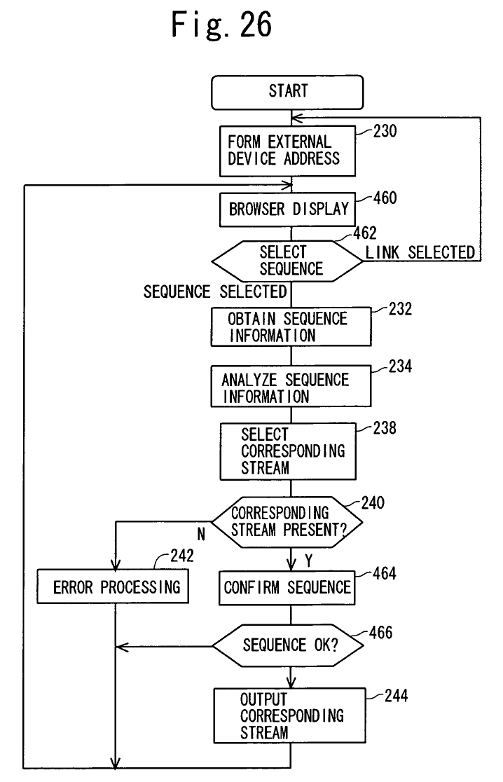

FIG. 26 is a flow representing a control structure of a program realizing the terminal apparatus 380 in accordance with the present embodiment. Referring to FIG. 26, the same steps as shown in FIG. 9 are denoted by the same reference characters. Therefore, detailed description thereof will not be repeated here.

Portions newly added in the flow chart of FIG. 26 are those following step 240, that is, step 460 of displaying the data obtained from the external device by the browser, and step 462 of determining whether a link to another web page is selected or sequence information is selected, as a result of operation by the user on the display given in step 460. If a link from the web page to another page is selected, control returns to step 230. In step 230, an address is set again to obtain new data, and the new page is displayed in step 460. If the user selects sequence information, control proceeds to step 232.

The program includes, in addition to the steps shown in FIG. 9, a step 464 of asking user's confirmation of the sequence to be output from now when it is determined in step 240 that the corresponding stream exists, and a step 466 of determining whether the stream should be output in accordance with the sequence, in accordance with user's answer of the previous step. If the user confirms the selected sequence in step 466, control proceeds to step 244. Otherwise, control proceeds to step 460.

In the present embodiment, user's confirmation is requested in step 466 immediately after the sequence information is downloaded, or at the start of executing the stream output in accordance with the sequence information, or at a timing of switching the stream. Such confirmation may be requested at various different timings.

When the sequence information is confirmed by the user in step 464 and the output of sequence information is instructed, it is desired that output be automatically switched from the browser to the stream output. Desirably, a key is prepared that can switch at one touch the display to a browser output to allow interruption of the stream output and selection of sequence information displayed immediately before or displayed near the stream output, even after the stream output is started. By setting the “Return to Browser” key, the user can move to a selection image at one touch when he/she wishes to select a different sequence while a stream is being output. For example, in the flow chart of FIG. 26, in the stream output of step 244, the stream output is interrupted in response to the input from the user, browser output of step 310 is resumed, and the immediately preceding URL is displayed.

The browser is not limited to an Internet browser, and it may be a browser that analyses and displays (outputs) data portion of satellite broadcast.

Further, in the error processing performed in step 242 of FIG. 26, information corresponding to the error may be obtained by accessing an external device. By way of example, when the stream is unavailable, equivalent stream of lower quality may be obtained from an external device. For this purpose, information for making an access to an external device at the time of an error may be included in the sequence information. This enables different manner of handling an error piece by piece of sequence information.

In the present embodiment, stream data output portion 118 converts the output of browser portion 396 to analogue video signals. The present invention, however, is not limited to such an embodiment. The signal output from stream data output portion 118 may be of any type, as long as it is adequate for the display device. Further, the stream output and the browser output may be signals of different types.

### Fifth Embodiment

In the fifth embodiment of the present invention, sequence information will be described that handles not only the information for designating and controlling a stream but also control information for displaying information of an external device.

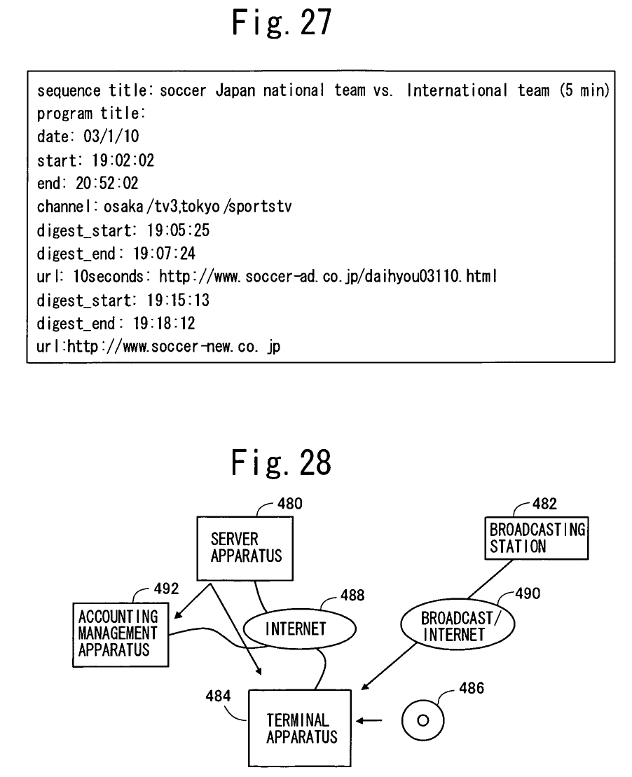

FIG. 27 shows the sequence information used in the fifth embodiment. Referring to FIG. 27, the sequence information is different from that shown in FIG. 6 in that an item “url:” is newly included, which designates information held by an external device. For example, in FIG. 27, the URL starting from “http://” corresponds to this.

In the example shown in FIG. 27, after the first pair of “digest_start” and “digest_end”, the URL “url: 10 seconds: http://www.soccer-ad.co.jp/daihyou03.html” can be found. Therefore, after the stream designated by “digest_start” and “digest_end”, the information at the address designated by “http://www.soccer-ad.co.jp/daihyou03.html” is displayed. Here, a designation of “10 seconds” is added, and therefore, after 10 seconds, sequencer portion 110 switches the display to the stream.

In the example shown in FIG. 27, there is a description “url:http://www.soccer-new.co.jp” on the last line. In this example, this description shows that after the output of the stream, information held by another external device will be output.

Here, an example is shown in which the information of the external device and the stream information are fully switched. The present invention, however, is not limited to such an embodiment. For example, when more detailed description of sequence information is made possible, the stream and the information of the external device can be output simultaneously. Such a configuration allows more flexible use.

By way of example, while a stream is being reproduced, information obtained from the external device (such as comments on a goal scene or advertisement) may be output as a telop at a lower portion of the image plane. Alternatively, the image plane may be divided and the information from the external device and the stream may be output together. When there are two or more stream decoders, two or more streams may be decoded simultaneously and output collectively as one output.

Here, SMIL as technique handling various media with time-related operation may be used, or a browser that can display a page described in such a language may be used.

It is desired that, when sequence information having such a description is obtained, an output mode for outputting both the information of external device and the stream or an output mode for outputting only the stream can be selected. This can readily be realized by the sequencer portion. By way of example, when the user wishes to watch the stream only and when the user wishes to check web news during watching the stream, the output mode can be switched. Further, such switching may be made using information from the external device. For example, an approach is possible that an advertisement is displayed as a web page between streams, while the advertisement page is not displayed to a pay-service subscriber. In that case, access to the web page can be prevented by using key information transmitted from the server (or access to a special page is allowed by the key).

### Sixth Embodiment

FIG. 28 shows an example of the overall system in accordance with the sixth embodiment of the present invention. The server apparatuses used in the first to fifth embodiments are basically simple enough to transmit appropriate sequence information in response to a request from a client. The server apparatus of the present invention, however, may have various additional functions, which make services provided by the system more satisfactory. The sixth embodiment mainly relates to such improvements to the server apparatus.

First, characteristics of the server apparatus in the system of the sixth embodiment will be described. The server apparatus in accordance with the present embodiment has the following four main characteristics. First, when a program table page linked to sequence information is transmitted, the contents of the program table page are dynamically changed in consideration of relation between the time of transmission and the time of broadcast of programs. Second, recording of a program can be reserved from the client to the server, and when sequence information of the reserved program is created, the sequence information can be automatically transmitted to the user. Third, coordination between a program and a product/service provider is made possible as information effective in view of business (such as advertisement tied-up with the contents of the program, or link information to a web site for product sales) is included in the sequence information. Finally, an accounting system is provided that allows the product/service provider to pay appropriately to the producer of the program, for such coordination between the program and the product/service provider. These characteristics will be discussed one by one in the following, and thereafter, the structure and operation of the present system will be described.

First, the concept of change of the contents of program table page in consideration of relation between the time of transmission and the time of broadcast of programs will be described. When a stream is transmitted using broadcast and sequence information corresponding to the stream is transmitted using a network, it is desired that the program information including the title, start time, end time, broadcasting station and the like of the program is transmitted together with the sequence information, to the terminal. Here, sometimes it is desirable not to transmit the sequence information before broadcast of the program but to transmit the sequence information after broadcast of the program, even if the sequence information has already been created before broadcast. When the user selects sequence information on the side of the terminal and the sequence information is obtained before the start of the program, the stream portion corresponding to the sequence information cannot be output, as the stream data is not yet held on the terminal. Further, even after the start of the program, such a control may be preferred on the server not to transmit the sequence information immediately in order to prevent the user from immediately viewing the digest. For example, the sequence information may be transmitted soon to paid client, while the sequence information will be transmitted one week later for unpaid client.

In such a case, it is desirable to dynamically control whether the sequence information corresponding to a certain program is to be included or not in the program table page to be transmitted, at the time when the program table page is created, based on the time of request for the program table page and the time of scheduled broadcast of respective programs. This control function is the first characteristic of the server apparatus in accordance with the present embodiment.

The second characteristic, that is, program reservation and automatic transmission of sequence information to the user who made the program reservation will be described. In most cases, the sequence information is created after the live coverage ends, as in the case of a sports digest. In that case, it is necessary for the user side to ask the server apparatus whether the sequence information of the program has been prepared or not. Such inquiry is troublesome. Therefore, the server apparatus in accordance with the present embodiment has the following function. Namely, when a user designates recording of a certain program, and the sequence program corresponding to the program is registered in the server apparatus, the sequence information is automatically transmitted to the terminal of the user.

Next, the third characteristic, that is, coordination between the program and product/service provider will be described. Recently, consumer preference much depends on clothes or products worn or used by an actor or actress in a program. Assume that a certain product appears as a property in the program and a link is set from the image plane of the program to the web site that provides the product or service. This would be convenient for a consumer as it enables easy shopping, and helpful for the seller to promote sales of the product, as the program serves as an advertisement. The server apparatus of the present embodiment provides such a function.

Finally, the accounting function will be described. In the coordination between the program and the product/service provider, the program plays a significant role. From the viewpoint of the product/service provider, the program itself has the function of advertisement.

By way of example, assume that a broadcasting station broadcasts a drama program, and a bag that appears in the drama is sold by an independent bag seller. Here, the broadcasting station and the drama make a huge contribution to the sales of the bag. Further, after viewing the actual contents (here, part of the program), the user decides to buy the product or the like that appeared in the program. Therefore, when such sequence information is stored in the server to be downloaded by the user, it would be reasonable that the seller of the corresponding product and the like pays some royalty to the broadcasting station, a producer company of the drama, or a copyright holder. For example, the royalty may be paid based on how many times the sequence information is downloaded.

Naturally, when the users are specified as in the case of a paid service, more effective system of sales can be built by transmitting user information to other management apparatus. For example, when a viewer of a drama downloaded digest information in which a bag of an actor playing “Mr. oΔ” appears, information including sequence information of a jacket worn by Mr. ** in another drama may be transmitted by a mail, so as to promote sales.

Therefore, in the server apparatus of the present invention, accounting function is provided to help the product/service provider to pay appropriate price to the program provider, when a user downloads sequence information including a link to the web site that sells some product, as described above, and the accounting information is transmitted to an accounting management apparatus. The server apparatus transmits accounting (payment) information calculated in accordance with the number of downloading of the sequence information or in accordance with a predetermined accounting condition, to an appropriate accounting management apparatus (server).

-Structure-

The structure of the present system will be described. Referring to FIG. 28, the system includes a server apparatus 480 as a core of the present embodiment, a terminal apparatus 484 used by the user and connectable to the server apparatus 480 through a communication path 488, and the accounting management apparatus 492 for the accounting management described above, which is also connectable to server apparatus 480 through communication path 488. The communication path is typically the Internet.

Server apparatus 480 is almost the same as sequence information providing apparatus 32 shown in FIG. 1. These apparatuses are the same in basic functions, while they differ as server apparatus 480 additionally has the above-described functions.

Terminal apparatus 484 has almost the same structure as terminal apparatus 38 shown in FIGS. 1 and 4. In the present embodiment, however, terminal apparatus 38 explicitly has the function of reproducing a packaged medium 486, and in this point, it differs from that shown in FIG. 1.

Terminal apparatus 484 is typically a personal computer (hereinafter referred to as a “PC”), a TV receiver, or a portable telephone. Terminal apparatus 484 includes a drive for a packaged medium such as a DVD. In place of a DVD, a flash memory or the like may be used, and the stream may be obtained also from a different device connected by a network to terminal apparatus 484. The structure of terminal apparatus 484 is the same as that shown in FIG. 4.

Referring to FIG. 28, the system further includes a broadcasting apparatus 482 sending streams of motion pictures, music and the like to terminal apparatus 484. Broadcasting apparatus 482 distributes a stream to terminal apparatus 484 through some medium 490 such as digital/analogue broadcast or stream distribution over the Internet. Therefore, terminal apparatus 484 can get the stream either from packaged medium 486 or stream distribution from broadcasting apparatus 482.

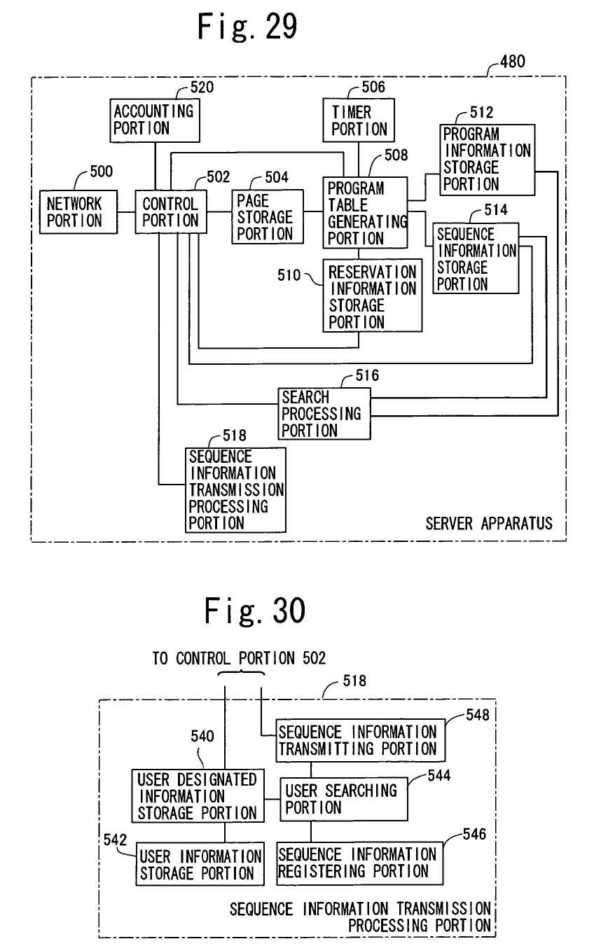

FIG. 29 is a functional block diagram of server apparatus 480. Referring to FIG. 29, server apparatus 480 includes a network portion 500 for communication with an external terminal, a control portion 502 for overall control of server apparatus 480, a program table page generating portion 508 generating a program table page, and a page storage portion 504 temporarily storing the generated communication information (page).

When transmission requests arrives from a large number of terminals in a short period of time, not all the transmission requests may be processed uniformly but pages temporarily stored in page storage portion 504 may be transmitted for a prescribed time period after generation of the program table page, so as to reduce the process on the server side.

Server apparatus 480 further includes a program information storage portion 512 storing information of a program to be broadcast. For terrestrial broadcast, program information storage portion 512 stores, region by region, program title, channel information, broadcast start time, broadcast end time and so on. It is possible to generate the program table based on the program information stored in program information storage portion 512. Here, the program table may cover all the programs of all channels, or it may simply represent one program.

Server apparatus 480 further includes a sequence information storage portion 514 storing the sequence information, a timer portion 506 generating a current time, and a reservation information storage portion 510 connected to program table page generating portion 508 and to control portion 502 for making recording reservation in accordance with user's designation. The reservation information stored in reservation information storage portion 510 includes, similar to the program information stored in program information storage portion 512, program title, channel information, broadcast start time, and broadcast end time. The reservation information is used by the terminal side (for example, user of terminal apparatus 484) for reserving recording. The reservation information is generally generated based on the information in program information storage portion 512.

Server apparatus 480 further includes: a search processing portion 516 for searching, program information storage portion 512 and sequence information storage portion 514, in response to a request from the user, for a program that matches the searching condition and the corresponding sequence information, respectively; a sequence information transmission processing portion 518 for automatically transmitting, when the sequence information of a program of which recording has been reserved by the user is created, the sequence information to the user; and an accounting portion 520 for performing an appropriate accounting process, when the sequence information is downloaded.

FIG. 30 is a block diagram of sequence information transmission processing portion 518. Referring to FIG. 30, sequence information transmission processing portion 518 includes a user designated information storage portion 540 connected to control portion 520 for storing program information of which recording has been designated by the user, and a user information storage portion 542 connected to user designated information storage portion 540 for storing a contact destination of the user terminal. The contact destination is, typically, an electronic mail address of the user.

Sequence information transmission processing portion 518 further includes: a sequence information registering portion 546 in which sequence information is registered at the time the sequence information is created; a user searching portion 544 connected to sequence information registering portion 546 and to user designated information storage portion 540, for searching, with respect to the sequence information registered in sequence information registering portion 546, for a user or a terminal that designated the program represented by the sequence information in the past from the user designated information storage portion 540; and a sequence information transmitting portion 548 for transmitting to the user searched out by user searching portion 544, the sequence information registered in sequence information registering portion 546 through control portion 502 and network portion 500 (see FIG. 29).

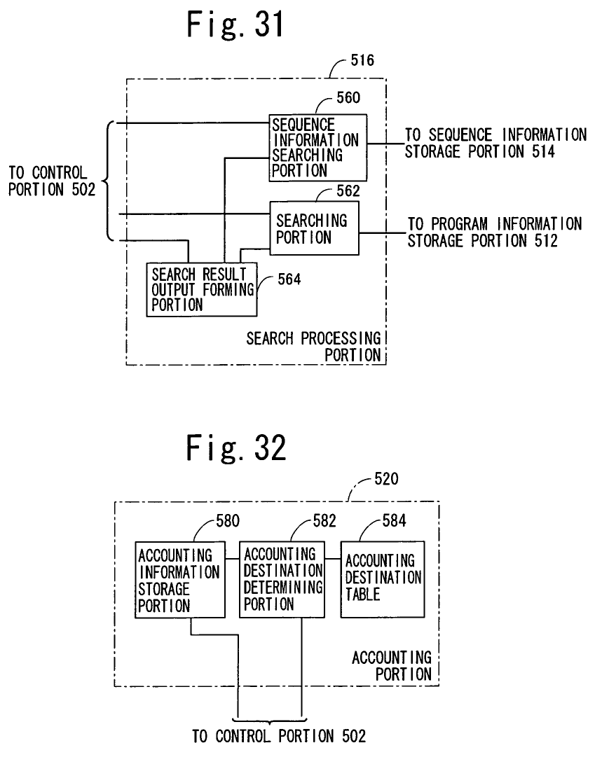

FIG. 31 is a block diagram of search processing portion 516. Referring to FIG. 31, search processing portion 516 includes: a searching portion 562 connected to control portion 502 for searching, based on the information stored in program information storage portion 512, for a program that corresponds to a search request transmitted from the terminal; a sequence information searching portion 560 for searching, from the sequence information stored in sequence information storage portion 514, for the sequence information corresponding to the program retrieved by searching portion 562; and a search result output forming portion 564 for forming a search result output combining the information related to the program retrieved by searching portion 562 and the sequence information retrieved by sequence information searching portion 560, and applying the formed output to control portion 502.

FIG. 32 is a block diagram of accounting portion 520. Referring to FIG. 32, accounting portion 520 includes an accounting destination table 584 for specifying a destination of accounting; an accounting destination determining portion 582 for determining an accounting destination in accordance with an instruction from control portion 502, when the sequence information stored in sequence information storage portion 514 is transmitted to a terminal in response to a request from the terminal; and an accounting information storage portion 580 for storing accounting information in accordance with the accounting destination information determined by accounting destination determining portion 582. The accounting information is transmitted to accounting management apparatus 492 shown in FIG. 28 once a day or on other basis. Here, “accounting” means information as a base for the manager of the present server apparatus to pay royalty to the proprietor (for example, broadcasting station) of the program specified by the sequence information.

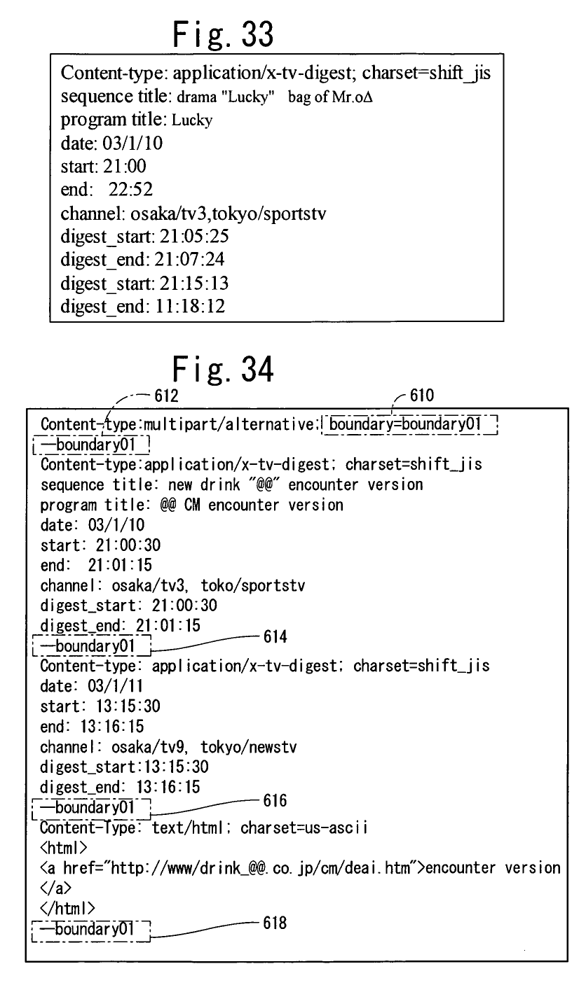

FIG. 33 shows an example of sequence information recorded in sequence information storage portion 514 of FIG. 29. The sequence information is similar to that shown in FIG. 6. It is noted, however, that in FIG. 33, the title of the stream information on the second line represents “bag of Mr. oΔ” in a drama “Lucky”.

As already described, the item “program title” on the third line represents the title of the stream, and in this example, it represents the drama “Lucky”.

Except for these points, the information is the same as that shown in FIG. 6. Therefore, detailed description thereof will not be repeated here.

The method of selecting an actual, corresponding portion of the stream from the sequence information shown in FIG. 33 differs medium by medium. If the stream is in a format in accordance with MPEG2 standard, for example, it can be realized by successively reading time stamps contained therein, or indexes of time and recording positions may be prepared in advance. It may be realized by issuing a command to an apparatus that seeks and reproduces with time designation. When data format such as MPEG2 that involves compression along the time axis is used, it may be impossible to start reproduction of a frame exactly at the designated time, because of GOP (Group Of Pictures) relation or the like. How to handle such situation is a practical design problem, and any measure may be taken.

FIG. 34 shows another example of the sequence information. This example is a sequence for selecting a commercial in a broadcast. A commercial itself is rarely recorded intentionally by a user, and hence, the user is generally unaware where the commercial is recorded. Further, it is often the case that the same commercial is broadcast a plurality of times or days on a plurality of channels. Therefore, it is desired that the sequence information have a plurality of options.

In the example shown in FIG. 34, as represented by the rectangular area of the first line, a character string “boundary01” of the first line is defined as a segmentation key word, and the following descriptions are segmented by this character string (as represented by rectangular areas 612, 614 and 616). The area between a pair of the character strings represents one piece of sequence information. In the example shown in FIG. 34, there are three blocks segmented by the character string “boundary01”. Specifically, there are three sequences prepared as possible options. The stream would be obtained from the three options, in accordance with respective sequence information, with the priority given in the order of blocks. If the desired stream could be obtained by the sequence information of a certain block, remaining block or blocks are skipped. Therefore, any of the plurality of blocks is selected in accordance with the order of description.

In the example shown in FIG. 34, in the first and second blocks, the same CM broadcast on different channels on two days, that is, Mar. 10 and 11 are described in parallel. In the third block, sequence information for accessing an HTML page is prepared. This means that when neither of the sequences described in blocks 1 and 2 is available from the terminal, the HTML page should be output as a default.

As one can be selected from a plurality of candidates, it is possible to access an appropriate source and to reproduce a program of the same contents broadcast repeatedly. Application of this approach is not limited to commercials. For example, this is applicable to broadcast from a station that reproduces one same program repeatedly, as in the case of cable television. Further, when there is big news and the news footage of the same contents is broadcast on a plurality of news programs, this approach can be applied to select one of the news programs.

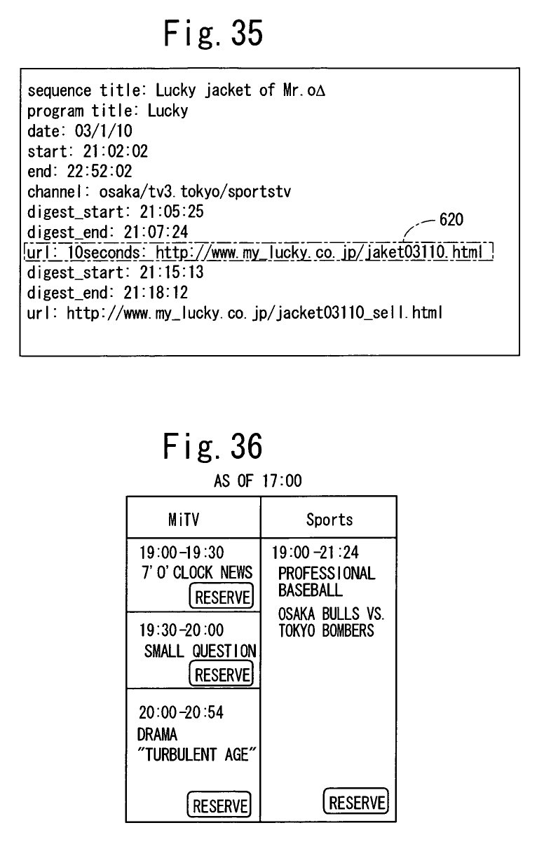

FIG. 35 shows an example of sequence information when stream reproduction and separate contents on the Internet are to be displayed alternately. The ninth line starting from the URL represents that Internet contents are displayed for 10 seconds after the first stream is reproduced. This sequence allows addition of separate description at every scene of the stream. Here, it may be fully or partially described by SMIL.

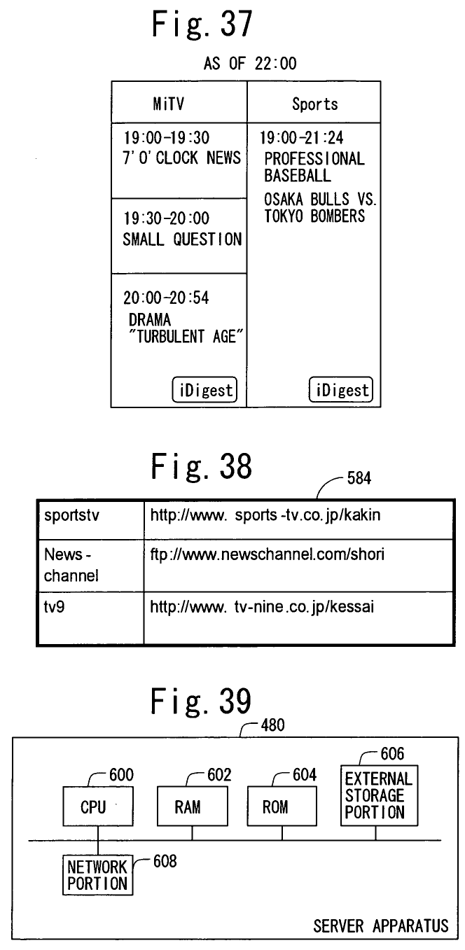

FIGS. 36 and 37 represent examples of program table pages transmitted from server apparatus 480 to terminal apparatus 484. As shown in FIGS. 36 and 37, the present embodiment is characterized in that the time when the program table page is requested and the broadcast time of the program are compared, and based on the result, the contents of the program table page are changed.

FIG. 36 is a program table page of around 19:00 of a certain day, provided at 17:00 of the same day. Here, program broadcast has not yet started, and therefore, a link button display is “reserve”, and this button is linked to information for recording. The recording information includes date of broadcast of the program and broadcasting station (channel) information. As the programs differ locally, it is desired that a program table of the region designated by the user or a terminal is prepared.

FIG. 37 is a program table page of around 19:00 of the certain day, provided at 22:00 of the same day. Here, broadcast of a baseball game and a drama has already finished. Further, it is assumed that sequence information of these programs has already been created. Here, the link button display has been changed to “iDigest”, and the button has a link to the sequence information described.

FIG. 38 is an example of accounting destination table 584 shown in FIG. 32. On the left column, channel information included in the sequence information is described. On the right side, server access information for accounting is described. From transmitted sequence information, channel information included therein is selected, and accounting information is transmitted to the corresponding server. When not only the channel but also the time information are referred to, it becomes possible to send accounting information to different servers program by program.

Server apparatus 480 is actually implemented by a computer. FIG. 39 is a hardware block diagram of server apparatus 480. Referring to FIG. 39, server apparatus 480 includes a CPU 600 for overall control of server apparatus 480, an RAM 602 used by CPU 600 as a work memory or the like, an ROM 604 for fully or partially storing a program or data, an external storage portion 606 formed of a hard disk for storing a program and data, and a network portion 608 for providing bidirectional communication to and from an external device through a network.

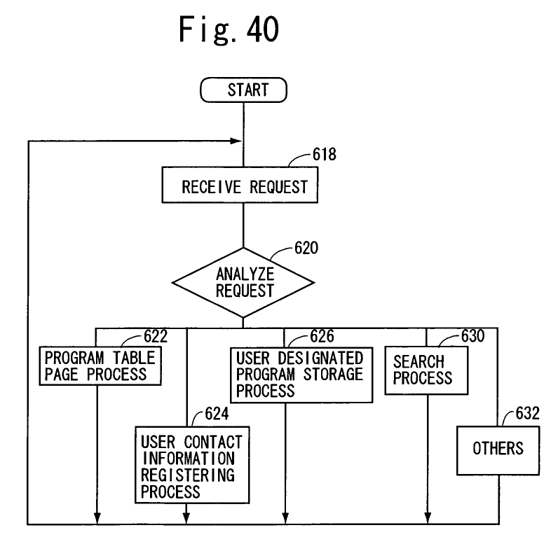

FIG. 40 shows, as a flow chart, a control flow of a program realizing the function of server apparatus 480 of the system in accordance with the present embodiment. Referring to FIG. 40, the program includes: a step 618 of receiving a transmission request from a terminal apparatus; a step 620 of analyzing the request and branching to steps 622, 624, 626, 630 and 632 in accordance with the contents of the request; a step 622 of performing a program table page processing in response to an occurrence of an event of program table page request; a step 624 of performing a user contact information registering process in response to an occurrence of an event of user contact information registering request; a step 626 of performing a user designated program storing process in response to an occurrence of an event of user designated program storage request; a step 630 of performing a searching process in response to an occurrence of an event of sequence information request; and a step 632 for other processing. In FIG. 40, detailed description of step 632 in which processes in response to requests not directly related to the present invention are performed, are omitted for simplicity of drawings and descriptions. This step, however, can readily be implemented by a person skilled in the art.

When these processes end, control returns to step 618.

In addition to these, processes performed by the server apparatus include a sequence information transmitting process executed in response to an occurrence of an event of sequence information transmission request, and a process for transmitting accounting information. These will be described later.

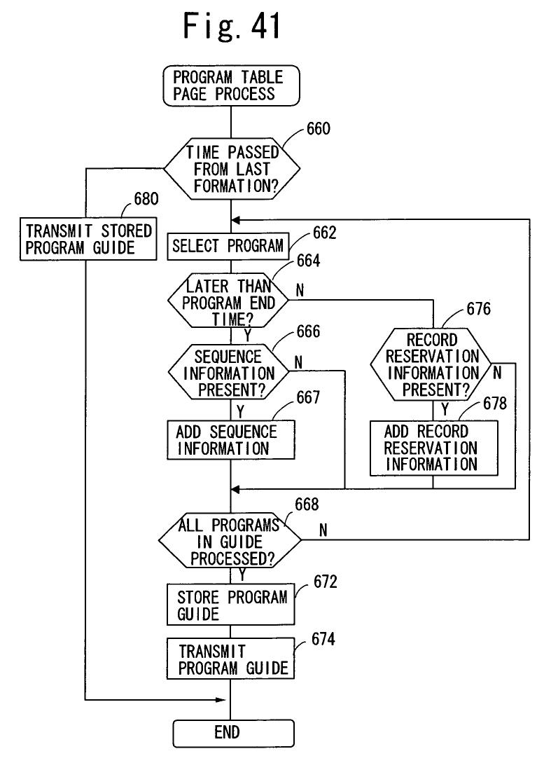

FIG. 41 is a detailed flow chart of the program table page processing performed in step 622 of FIG. 40. Referring to FIG. 41, the program table page processing includes a step 660 of determining whether a prescribed time has passed from the last transmission request or not. Setting of update time here is about one minute to about one hour, though it depends on the frequency of update of the sequence information or program information. If the prescribed time has not yet passed, a program table page that has been created and temporarily stored is transmitted (step 680), and the process ends. Otherwise, control proceeds to step 662.

In step 662, program of the program table page to be transmitted in response to the outstanding transmission request is selected. In step 664, whether the current time is later than the end time of the corresponding program in the program table page or not is determined. If it is later, control proceeds to step 666, and otherwise, control proceeds to step 676.

In step 676, the program end time is not yet arrived, and therefore, whether there is information (record reservation information) including link destination information to a file of record reservation information for making reservation of recording the program or not is determined. If there is such information, control proceeds to step 678, and otherwise control proceeds to step 668. In step 678, a process for adding the record reservation information is performed. Specifically, a link button to the selected record reservation information file is added to the corresponding program information of the program table page to be transmitted. Thereafter, control proceeds to step 668. Processes after step 668 will be described later.

If it is determined in step 664 that the current time is later than the program end time, in step 666, as the program end time has already passed, whether there is sequence information corresponding to the program of interest in the program table page or not is determined. In the next step 667, the sequence information of the program is added to the program table page information. Specifically, to the information of the program of the program table page to be transmitted, a link button to the selected sequence information file is added. Then, control proceeds to step 668.

In step 668, whether all the programs in the program table page corresponding to the outstanding request have been processed or not is determined. When all the programs have been processed, control proceeds to step 672. If not, control returns to step 662 in order to process the next program.

In step 672, all the programs have been processed, and therefore, the finished program table page is stored in page storage portion 504 (see FIG. 29). Here, the time of formation of the program table page is also stored simultaneously. In the next step 674, the program table page stored in step 672 is transmitted to the terminal apparatus that is the source of the request, and the process ends.

In the process above, the program table page is updated only when a prescribed time period has passed from the last request. The present invention, however, is not limited to such an embodiment. For example, the program table page may be updated in response to an occurrence of an event that a manager of the server apparatus 480 or a sequence information manager has registered sequence information. Alternatively, the program table page may be created every time a transmission request is issued, without determining whether a prescribed time period has passed from the last transmission request.

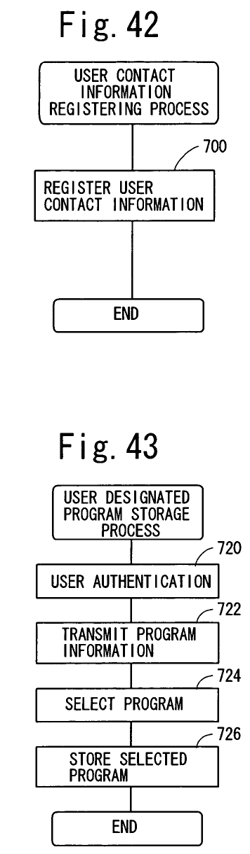

FIG. 42 shows, in the form of a flow chart, a control structure of the user registration process performed in step 624 of FIG. 40. Referring to FIG. 42, prior to the user registration process, the user of the terminal apparatus transmits a request for registering user contact information to server apparatus 480. The user contact information is necessary to receive the transmission of sequence information later, from server apparatus 480. In response to the event that the request is received, server apparatus 480 stores the transmitted user contact information in user information storage portion 542 shown in FIG. 30 (step 700). It is often the case that a user ID (identification information) for the next and future access is issued to the user. By the use of user ID the next time, the contact information of the user can be specified on the server side. The user contact information is given by the user inputting, by way of example, the mail address.

FIG. 43 is a flow chart of the user designated program storing process performed in step 626 of FIG. 40. Referring to FIG. 43, the process includes step 720 of user authentication. For example, when the user or the terminal transmits user ID issued in step 700 of FIG. 42 to server apparatus 480, the contact information can be specified. In order to prevent a so-called “spoofing”, that is, a user making a request using a user ID of a different user, the user ID may be verified using a pass word transmitted from the side of the terminal apparatus.

This process further includes a step 722 of transmitting the stored program information to the terminal, and a step 724 of selecting one or a plurality of programs from the program information transmitted to the terminal side. The program information transmitted in step 722 may be in the form of a program table or simple program introduction. The process of step 724 can be realized, for example, by describing the program information in HTML, with a link button or a text link linked to an URL for “registration” provided in association with each program, which the user presses.

At this time, on the terminal side, the user may select a program manually, or a program may be automatically designated by matching performer information and category information such as sports or drama included in the program information with preference information of the user registered beforehand. When automatic designation is done, it is preferred that on the user terminal, a program designated in accordance with the preference information has been selected from the program information as a program matching user's taste and recorded. As the program matching the preference is recorded and the sequence information matching the preference is selected and transmitted from the side of the server, both the recording and the sequence information of the corresponding program can automatically be obtained, simply by one input of preference by the user. In this case, the sequence information is preferably transmitted after the end of transmission and recording of the program.

After step 724, the program selected in step 724 is stored, paired with the user information, in the user designated information storage portion 540 of FIG. 30.

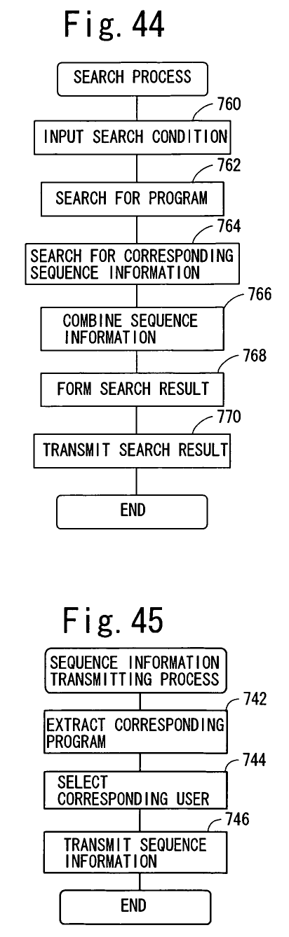

FIG. 44 is a flow chart of a search process performed in step 630 shown in FIG. 40. It would be convenient if it is possible for the user to obtain sequence information not only by checking a program table page but also by selecting a program through searching. The process shown in FIG. 44 enables such a search process. Prior to this process, it is assumed that the user transmits a search request including a search condition to server apparatus 480.

Referring to FIG. 44, the search process includes a step 760 of obtaining the search condition included in the request from the terminal, a step 762 of searching for a program that matches the search condition from program information storage portion 512 (the function corresponding to searching portion 562 of FIG. 31), a step 764 of searching sequence information corresponding to the program searched out in step 763 from sequence information storage portion 514 (the function corresponding to sequence information searching portion 560 of FIG. 31), and a step 766 of connecting the sequence information searched out in step 764 for creating one sequence information, according to a setting or the like on the terminal side. Step 766 is to connect pieces of sequence information of searched out programs to provide, as one piece of sequence information, the searched out programs. When this connected sequence information is used, it becomes possible, when “singer oΔ” is searched, to reproduce a plurality of scenes, in which the singer oΔ appears, connected to each other.

The process further includes a step 768 of creating a search result combining the result of program search in step 762 and the result of sequence information search in step 766 (corresponding to search result output forming portion 564 of FIG. 31), and a step 770 of transmitting the search result.

FIG. 45 is a flow chart of the sequence information transmitting process. The process is executed in response to an occurrence of an event that sequence information of a certain program is registered in sequence information registering portion 546 of FIG. 30.

Referring to FIG. 45, the process includes a step 742 of selecting, from the program information included in the registered sequence information, a corresponding program, and a step 744 of selecting a user who has selected the corresponding program in the past. The selection is made using the user information and the program information stored in step 726 of FIG. 43. Thereafter, in step 746, to the contact destination of the user selected in step 744, the sequence information registered by sequence information registering portion 546 shown in FIG. 30 is transmitted, and the process ends.

Here, an example has been described in which the sequence information is transmitted when the sequence information is registered. The method of implementing the present invention is not limited to this. For example, a process of checking whether there is a newly arrived sequence information or not may be performed at every prescribed time period, and the process described above may be performed every time a newly arrived sequence information is found.

Once the sequence information desired by the user has been transmitted from server apparatus 480 to the user terminal in the manner as described above, it follows that the user reproduces and enjoys the recorded stream in accordance with the sequence information. When the sequence information includes link information to a web site that provides products and the like as described above, the operator of the server having the sequence information can promote its business smooth, using the recorded contents. Therefore, it is reasonable that the operator pays some price to the proprietor of the stream. Therefore, when the sequence information is transmitted to the user, it is necessary to calculate accounting information for the operator having the sequence and to transmit the accounting information to accounting management apparatus 492 shown in FIG. 28.

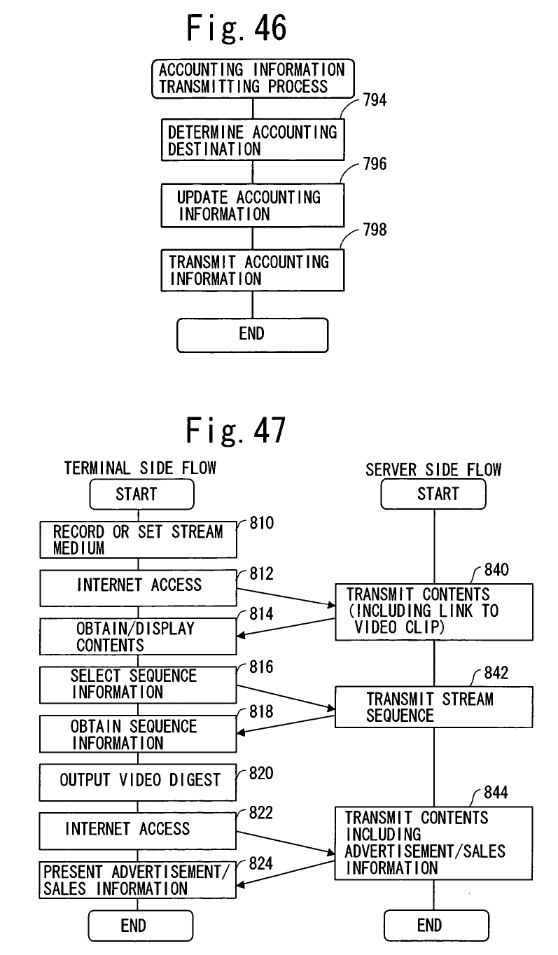

FIG. 46 shows a flow of transmitting the accounting information for this purpose. Referring to FIG. 46, the process is activated in response to an occurrence of an event that sequence information is transmitted to a terminal apparatus. The process includes a step 794 of determining an accounting destination using information included in the transmitted sequence information and making reference to the accounting destination table shown in FIGS. 32 and 38. Here, a server address to which the accounting information is to be transmitted is determined.

In step 796, information related to the sequence information transmitted this time is added to the accounting information managed destination by destination of accounting, whereby the accounting information is updated. Specifically, the number of downloading the sequence information is counted up. Thereafter, in step 798, the accounting information is transmitted to the server of the proprietor of the stream. In the present embodiment, the accounting information is transmitted every time the sequence information is transmitted. The accounting information, however, may be transmitted collectively to respective servers at a prescribed timing.

-Operation-

The present system operates in the following manner. First, an ordinary operation will be described in which the user views a program table page including a list of sequence information or a link to the sequence information, and selects a piece of sequence information therefrom.

FIG. 47 shows an example of communication in such an operation between server apparatus 480 and a terminal apparatus. The left side of the figure represents a flow showing the process on the terminal apparatus, and the right side represents the flow showing the process on the server apparatus. First, in step 810 on the terminal side, a stream is obtained. Typically, a broadcast program is recorded, or a packaged medium is set to its drive. When a stream data is obtained at will by accessing a network, this portion may be unnecessary.

Then, in the terminal apparatus, a transmission request is sent to server apparatus 480 (step 812). Upon this request, server apparatus 480 transmits contents to the terminal, in step 840. The contents are typically a piece of information written in a language such as HTML. In most cases, still images, motion picture data and the like are transmitted together, in accordance with HTTP protocol and the like, to the terminal apparatus.

It is noted that the contents includes a link to sequence information for reproducing a stream that can be accessed by the terminal side. The link may be access information described as a URL, and the sequence information can be obtained in accordance with the access information.

Thereafter, in step 814, the terminal apparatus displays the contents transmitted from server apparatus 480. Multimedia data such as music may be reproduced simultaneously. On the terminal side, in the next step 816, among the contents reproduced in step 814, the user selects a link to sequence information for a stream that can be accessed from the terminal. By this selection, a request for the sequence is transmitted to server apparatus 480.

In response to the request, the server transmits the sequence information to the terminal apparatus in step 842.

On the terminal side, the information is received in step 818. Further, in step 820, based on the information obtained in step 818, the stream prepared in step 810 is reproduced. The stream to be reproduced may be video images or music. When reproduction of the stream ends, in step 822, an access is made again to the Internet. Specifically, to the server apparatus, a request is transmitted for contents designated after the end of digest output in the sequence information obtained in step 818.

In response to the event that the request is received, the server apparatus transmits the designated contents to the terminal apparatus. The contents may include the stream itself, information of product or information that appears in the stream, or a link to such information. Alternatively, the contents may include sales information of such product or a link to the sales information.

When the contents are obtained and displayed in step 814, the sequence obtained in the process of steps 816 and 818 may simultaneously be obtained. Further, steps 812, 814 and 816 may be omitted and the server apparatus may transmit the sequence information to the terminal apparatus without any request from the terminal apparatus.

For this purpose, it may be possible to send the sequence information by an electronic mail. This method corresponds to the sequence information transmitting process described above.

In this example, when stream reproduction ends, transmission of new Internet contents is requested in step 822. Naturally, the control may return to the display before the start of stream reproduction. Further, product advertisement/sales information may be displayed from the start, together with the link to the sequence information of the stream.

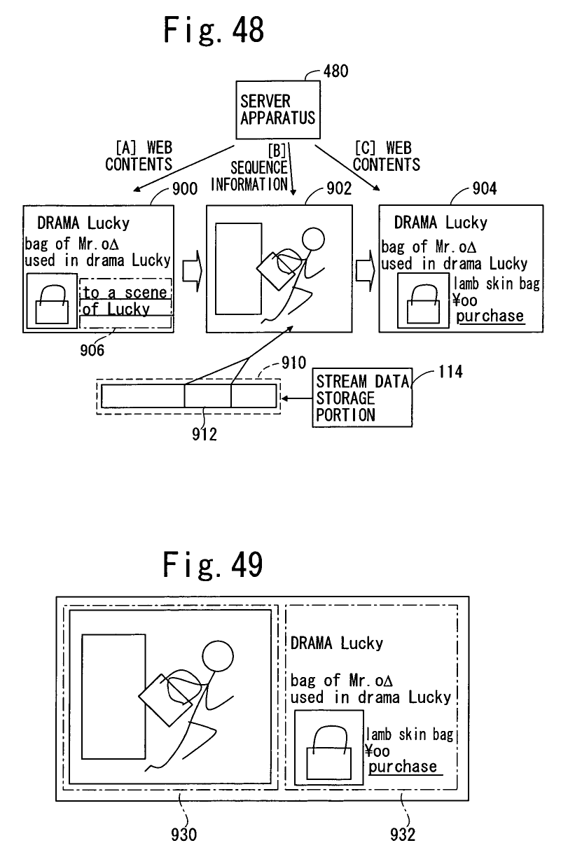

FIG. 48 is an illustration related to images displayed when the terminal apparatus and server apparatus 480 operate in accordance with the operation flow shown in FIG. 47. In this example, it is assumed that the process of step 810 has been finished. In the middle of FIG. 48, an exemplary display on terminal apparatus 484 is shown.

An image plane 900 is an exemplary display given when step 814 is finished. In this example, it is assumed that television broadcast of a drama “Lucky” has been already finished, and the drama is recorded and stored as a stream in stream data storage portion 114 (see FIG. 4) of the terminal apparatus. Further, it is assumed that the user is viewing a web page related to the drama.

Referring to FIG. 48, at a lower right portion of image plane 900, there is a piece of link information 906 “to a scene of Lucky”. When this link is selected, the corresponding sequence information is transmitted from server apparatus 480 to the terminal apparatus. Though the sequence information is assumed to be in the server holding the contents of image plane 900 in this example, it may be held in a different server. On the web, a request for sequence information is commonly designated by a URL.

An image plane 902 shows an exemplary display appearing on the terminal apparatus when the link is selected and the sequence information is received by the terminal apparatus. This corresponds to the display given in step 820 of FIG. 47. Specifically, when the user selects the sequence information corresponding to link information 906 at the lower right portion of image plane 900 and the terminal apparatus receives the sequence information from server apparatus 480, the terminal apparatus selects and reproduces a portion 912 designated by the received sequence information, from the stream 910 (in this example, recorded TV program) stored in the stream data storage portion 114 of itself. In this example, “the scene in which Mr. oΔholds the bag” of the stream is displayed.

When reproduction of the stream in accordance with the sequence information ends, steps 822 and 824 of FIG. 47 are executed, and the display of image plane 904 of FIG. 48 appears. In this example, a web page including the product information of the bag is displayed. At the destination of the link from this page, there is a sales system. Such a sales system can be realized by conventional technique, as described in Japanese Patent Publication No. 9-500470.

In this example, when link information 906 on image plane 900 is selected, the image automatically switches from the web page to the video reproducing image, and when reproduction of the video images ends, the image automatically switches to the web page display. In this manner, by selecting link information, a series of video images can be enjoyed and related product can be readily available, without any further operation by the user, and hence, it is very convenient.

As another possible implementation of the terminal, reproduction 930 of a stream and web contents display 932 may be provided simultaneously, as shown in FIG. 49.

Next, an operation of the terminal apparatus and the server apparatus will be described in which the user reserves recording in advance, and when the sequence information of the reserved program is registered, the sequence information is automatically transmitted to the terminal apparatus of the user.

Prior to this process, first, the user registers contact information of himself/herself in user information storage portion 542 shown in FIG. 30. A form for registration is distributed to the terminal apparatus of the user from the web server, as an HTML document. Using the information transmitted from the form, the contact information of the user is recorded in user information storage portion 542 in step 624 of FIG. 40.

Next, the user reserves recording. In the present embodiment, a form for recording reservation is distributed to the terminal apparatus of the user from the web server, as an HTML document, and the recording reservation information transmitted from the form is registered in user designated information storage portion 40 of FIG. 30, by user designated program storing process 626 performed in step 626 of FIG. 40.

Though not described in detail in the present embodiment, it is assumed that the server apparatus and the terminal apparatus have a function that the program registered in user designated information storage portion 540 is automatically recorded in the terminal apparatus of the user.

When broadcast of the designated program ends, generally, sequence information of the program is created by a manger of server apparatus 480. By way of example, when the program is sports coverage such as a baseball game, soccer, rugby, sumo or tennis, sequence information realizing a digest of high-light scenes is created. When the sequence information is created, the sequence information is applied to and stored in sequence information storage portion 514 shown in FIG. 29. Information that the sequence information of the program has been stored in sequence information storage portion 514 is applied to sequence information registering portion 546, and is stored as sequence information to be transmitted to the user.

User searching portion 544 searches user designated information storage portion 540 for a user that reserved recording of the sequence information registered by sequence information registering portion 546. If there is any such user, the contact information (electronic mail address) of the user is retrieved from user information storage portion 542, and is fed to sequence information transmitting portion 548.

Sequence information transmitting portion 548 transmits the sequence information registered by sequence information registering portion 546 to the electronic mail address of the user fed from user searching portion 544.

Having received the electronic mail, the user can obtain the latest sequence information prepared for the stream recorded in his/her terminal apparatus. By selecting the sequence information, the user can enjoy a digest of the recorded stream.

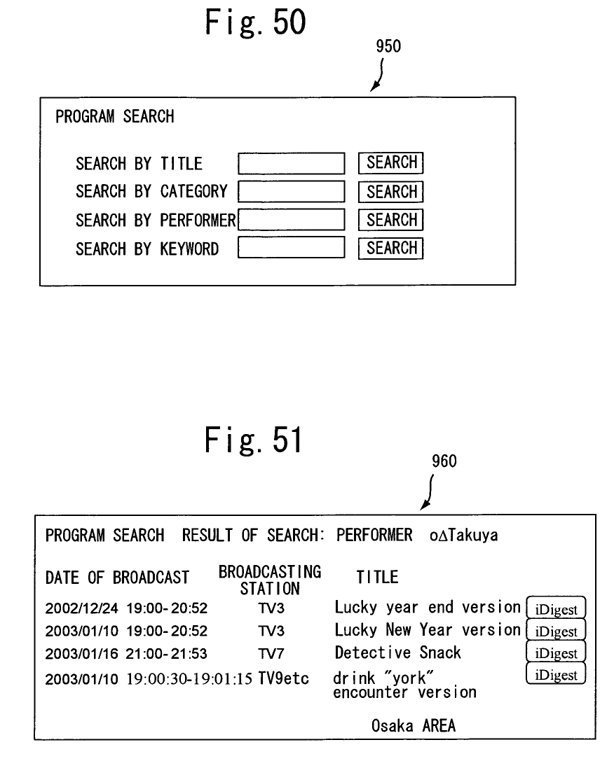

Next, an operation of the terminal apparatus and the server apparatus when the sequence information is obtained through a search will be described. FIGS. 50 and 51 show an example of getting sequence information through a search. In the present embodiment, an HTML document realizing a form for searching is prepared in the server apparatus, and in response to a request from the user, the form is transmitted to the terminal apparatus. This operation can readily be realized by a common web server.

Form 950 of FIG. 50 is presented to the user for searching a program, realized when the HTML document transmitted in such a manner is displayed by a browser. This is an example for searching for a program through a generally known method of searching, using full or partial match of title, category, performer, keyword and the like.

A desired keyword is input to the search field of form 950, and transmitted from the terminal apparatus to the server apparatus 480. Referring to FIG. 31, searching portion 562 of server apparatus 480 receives this information, and searches program information storage portion 512 (see FIG. 30) for a corresponding program. Search result output forming portion 564 combines results of search, and applies the result to control portion 502. Control portion 502 transmits the result of search to the terminal apparatus, and the terminal apparatus displays the result of search.

An image 960 shown in FIG. 51 is an example of search result screen displayed on the terminal apparatus, when a search was conducted by a performer name “oΔTakuya”, using the form 950 shown in FIG. 50. Here, programs or CMs in which the actor “oΔ Takuya” appears are displayed, together with the time of broadcast, channel information and title information.

Referring to FIG. 51, on the fourth line of the searched programs, there is a description “etc” in “TV9 etc”. This line corresponds to a CM, which is broadcast many times. Therefore, only the representative time and channel are described as the date and channel of broadcast, and it is indicated that the CM is also broadcast on other date and other channels. Here, not only broadcasts but also stream contents on the Internet may be included in the search objects.

The button “iDigest” on the right most portion of the search result in FIG. 51 is for downloading the sequence information. The button has a link to the corresponding sequence information embedded therein, and if the button is pressed, the corresponding sequence information is downloaded. When there are a plurality of broadcasts as in the case of the CM as the fourth result, corresponding pieces of sequence information are described in parallel, and at the time of reproduction, the streams are desirably obtained in accordance with the order of priority.

In the present embodiment, a search form such as shown in FIG. 50 is presented to the user for searching. This can be realized by preparing an HTML form for searching in the server apparatus in advance, and by transmitting the form to the terminal apparatus.

It is not essential to present such a form to the user. It is possible to simply transmit sequence information in response to a search request transmitted in a prescribed format, as in the example in which the terminal transmits a search request to the server apparatus, and the sequence information is downloaded appropriately. Such an example realizes that once a user simply inputs some keyword, the sequence information can be automatically downloaded.

Every time the sequence information is downloaded, the accounting information for the relevant accounting destination is updated by accounting processing portion 520 and the accounting information is transmitted to an accounting server, as already described above.

In each of the embodiments above, a program has been described as a unit for an operation of the system, and the digest has been described as a number of scenes extracted from one and the same program and combined. The present invention, however, is not limited to such an embodiment. By way of example, a set of programs may be treated as a unit of operation, and one program of the set may be treated as the digest described in the embodiments above. The digest may be a program itself. In such a case, selection of a digest may simply be a selection of a program, or a combination of a plurality of programs.

In the embodiments described above, any problematic situation in selecting a stream from sequence information is not considered. Actually, however, the necessary streams for reproduction in accordance with the sequence information may not be fully saved locally. For example, only a part of the necessary streams may be locally held, or necessary portions are not at all saved while the stream itself exists. The terminal apparatus must be configured considering such situation.

By way of example, when only a part of a stream is available, only the available portion is reproduced and a warning is given to the user at the beginning as to the portion that cannot be reproduced. When the stream does not include any available portion, control may proceed to the error processing of step 24 shown in FIG. 26.

Further, in the embodiment above, it is assumed that the digest is reproduced on the terminal apparatus in accordance with the sequence information. The usage of sequence information, however, is not limited thereto. For example, when the digest only is to be dubbed in an apparatus different from the terminal apparatus, such as a portable telephone, the sequence information may be used to dub only the selected scenes. For example, the digest may be dubbed in a memory card, and the memory card may be mounted on the portable telephone. In that case, it is effective to simultaneously convert to images of an appropriate size, considering the size of the screen of the reproducing apparatus such as the portable telephone. Simultaneous conversion of data format is more preferable. When a digest consisting of a plurality of scenes, a scene change indication may preferably be inserted between each scene.

In the embodiment above, it is assumed that the sequence information is transmitted through the web. The present invention, however, is not limited to such an embodiment. For example, the sequence information may be transmitted using a vertical blanking period of television signals of the program, or in a data period of digital broadcast.

As described above, according to the present embodiment, the sequence information is for designating what portions of the stream data should be reproduced in what order. The stream data is, by way of example, video images recorded on a recording medium such as a hard disk. Contents of these are related to each other by time information or the like while these two can be moved independent from each other.

Generally, in order to segment a part of stream data, it is necessary to designate start time and end time. In the sequence information of the present embodiment, however, the broadcast time of the sequence data is adapted as the reference for the time. As a result, even when a part of the program is to be cut out based on the sequence information, it is unnecessary to consider the start time of recording, end time of recording, whether the program is recorded as a whole, what bit rate was used for recording, and so on. Therefore, reproduction of stream data in accordance with the sequence information is not influenced by the environment of the viewer. As a result, it is unnecessary to provide any condition for reproducing the stream data, and the sequence information can be distributed widely.

For example, in an apparatus storing the stream data, by obtaining the sequence information from an external device, it becomes possible to readily output a digest of the stream data. In the video distribution service using stream data, when the sequence information of the stream data is created and provided by a service provider other than the user, it becomes possible for an ordinary user to always enjoy the digest (or an appropriately edited stream data) of the stream simply by obtaining the sequence information.

Further, it is possible to connect to apparatuses of different service providers by designating addresses. Therefore, a desired piece of sequence information can be selected and obtained from among pieces of sequence information created by a plurality of service providers.

In the present embodiment, material forming a scene is not only the stream data but may include any material that can be obtained through various means at the time of reproducing the sequence information, such as character strings embedded in sequence information, still images, or information on the Internet. Specifically, the sequence information can be coordinated with various media. As a result, compared with simple copy and paste of portions of stream data, the finished video images can include larger information such as text and can be made more comprehensible.

It becomes easier to control the Internet information (web) and the video images by the sequence information. This enables display of additional information obtained from the Internet on the video image digest, or display of advertising information obtained from the Internet between video images.

Further, the information of the stream data currently viewed by a user may be generated as sequence information and transmitted to another device. When a user watches certain stream data on TV and wishes to watch the remaining part on a portable telephone, the information of the remaining part can be transmitted as the sequence information from the TV to the portable telephone. This is more effective when the stream data exists on the Internet. Similarly, it is possible that a service provider, different from the user, transmits sequence information to the user and the user views the stream data in accordance with the stream data. Thus, it becomes possible for individual user to get necessary information quickly, simply by viewing only the portions selected by the service provider, without the necessity of viewing all the stream data.

As described above, from the characteristics that the sequence information and the stream data are independent from each other and that the sequence information can be coordinated with various media, the sequence information of the present invention realizes highly sophisticated expression. On the other hand, in order to cope with an error that an unrecorded point is designated by the sequence information, the sequence information can designate an error processing. For example, when a stream data that is not available is designated by the sequence information, various error processing can be done, such as designating a specific character string, or displaying information obtained from a prescribed URL. As a result, independence between the sequence information and the stream information can be enhanced, and video reproduction with more sophisticated expression can be realized.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

As described above, the present invention enables various and many pieces of information provided by various media to be used by various users including ordinary consumers, in various manners matching the users' need or preference. As a result, the present invention can be used for a video or music reproducing apparatus for general consumer. Further, by the present invention, distribution of sequence information that can be used by ordinary consumer when reproducing information can be promoted. As a result, the present invention can be used in the industry that form such sequence information or that provides consumers with such sequence information.

1. A stream output apparatus comprising:
sequence information obtaining means for obtaining sequence information indicating a reproduction sequence of stream data;
stream information obtaining means for obtaining attribute information of stream data; and
sequencer means for obtaining stream data ready for use with the sequence information obtained and stored by said sequence information obtaining means through matching between said sequence information and said attribute information of said stream data, and for outputting the stream data in accordance with a sequence designated by the sequence information.

2. The stream output apparatus according to claim 1, wherein
said sequence information obtaining means includes
message receiving means for receiving an electronic message transmitted from an external device to the apparatus, and
sequence information extracting means for extracting sequence information included in the message received by said message receiving means; and
the sequence information is extracted from a message transmitted to said stream output apparatus and stream data corresponding to the sequence information is obtained and output.

3. The stream output apparatus according to claim 1, wherein
said sequence information obtaining means includes
a browser portion obtaining and displaying information held by an external device, and
means for obtaining sequence information presented by said browser portion and corresponding to information selected by a user.

4. The stream output apparatus according to claim 3, wherein
said browser portion includes a browser for displaying an electronic program table linked to the sequence information.

5. The stream output apparatus according to claim 4, wherein
said electronic program table includes information for making a reservation to obtain the sequence information;
said stream output apparatus further comprising
means for performing a process for reserving the sequence information, in accordance with the information for making a reservation.

6. The stream output apparatus according to claim 3, further comprising
mean for automatically switching, when a user designates sequence information using said browser portion to an output of stream data that corresponds to the designated sequence information.

7. The stream output apparatus according to claim 3, further comprising:
means for receiving an instruction from a user to stop output of stream data; and
means for switching an output of said browser to a predetermined display output (460), in response to said instruction to stop.

8. The steam output apparatus according to claim 7, wherein
said switching means includes means for switching an output of said browser to a display output for selecting output stream data, in response to said instruction to stop.

9. The stream output apparatus according to claim 3, further comprising:
means for determining whether stream data included in sequence information displayed by said browser portion is accessible from the stream output apparatus or not; and
means for controlling said browser portion to display sequence information displayed by said browser portion in different manner dependent on the result of determination by said determining means.

10. The stream output apparatus according to claim 1, further comprising:
stream receiving means for receiving stream data from an external apparatus; and
stream storage means for storing the received stream data; wherein said sequencer means includes means for obtaining, from said stream storage means stream data that corresponds to the sequence information obtained by said sequence information obtaining means, through matching between said sequence information and said attribute information of said stream data, and for outputting the stream data in accordance with a sequence designated by said sequence information.

11. The stream output apparatus according to claim 10, further comprising:
means for determining whether stream data corresponding to sequence information is stored in said stream storage means or not; and
means for outputting information obtained from a prescribed information source, in response to a determination that said stream data corresponding to said sequence information is not stored in said stream storage means.

12. The stream output apparatus according to claim 11, wherein
said means for outputting information obtained from a prescribed information source includes substitute information preparing means for preparing information as a substitute for the stream data corresponding to said sequence information.

13. The stream output apparatus according to claim 1, further comprising:
means for generating a device address holding sequence information corresponding to the stream data, based on the attribute information of the stream data obtained by the stream information obtaining means; wherein
said sequence information obtaining means includes means for obtaining sequence information corresponding to the stream data obtained by said stream information obtaining means, based on said device address.

14. The stream output apparatus according to claim 1, wherein
said sequencer means includes means for combining and outputting an output of stream data and output of information obtained from an external device connected through a network, in accordance with the sequence information.

15. The stream output apparatus according to claim 14, further comprising:
means for holding output control information representing a manner of combination at the time of output of information obtained from an external device and the stream data; and
means for outputting the output of the stream data and the information obtained from the external device in accordance with the manner of combination represented by said output control information.

16. The stream output apparatus according to claim 15, further comprising
means for obtaining said output control information from a device connected to said stream output apparatus through a network.

17. The stream output apparatus according to claim 14, wherein
said sequence information includes
information representing a reproduction sequence of stream data, and
output control information representing a manner of combination at the time of output of information obtained from an external device and the stream data; and
said stream output apparatus further includes
means for outputting the output of the stream data and the information obtained from the external device in accordance with the manner of combination represented by said output control information.

18. The stream output apparatus according to claim 1, wherein
said sequence information includes
information representing a reproduction sequence of stream data, and
information to be output combined with the stream data; and
said sequencer means includes means for combining the output of stream data and said information to be output, and for outputting.

19. The stream output apparatus according to claim 18, further comprising:
means for holding output control information representing a manner of combination at the time of output of said information to be output and the stream data; and
means for outputting the output of the stream data and said information to be output, in accordance with the manner of combination represented by said output control information.

20. The stream output apparatus according to claim 19, further comprising
means for obtaining said output control information from a device connected to said stream output apparatus through a network.

21. (canceled)

22. The stream output apparatus according to claim 1, wherein
said sequencer means includes
searching means for searching for stream data ready for use with a reproduction sequence represented by said obtained sequence information,
search stream selecting means for selecting any of stream data obtained by the search by said searching means, and
means for obtaining the stream data selected by said search stream selecting means and for outputting the stream data in accordance with a sequence designated by said sequence information.

23. The stream output apparatus according to claim 22, wherein
said sequence information includes predetermined attribute information related to stream data used for the sequence information, and said attribute information is of such a nature that cannot specify stream data to be obtained solely by said attribute information; and
said searching means includes means for searching stream data that matches with the attribute information related to the stream data designated by said obtained sequence information.

24. The stream output apparatus according to claim 23, wherein
said search stream selecting means includes
means for presenting stream data obtained by the search by said searching means to a user for urging the user to designate any of the stream data, and
means for selecting the stream data designated by the user through the designating means.

25. A computer readable recording medium storing a computer program controlling, when executed by a computer, said computer to operate as the stream output apparatus according to claim 1.

26. A stream output method of outputting stream data in a stream output apparatus connected to a network, comprising the steps of:
forming an address designating a device connected to the networks;
accessing said address to obtain sequence information of stream data;
selecting stream data that matches the sequence information through matching between the obtained sequence information and attribute information of locally stored stream data and
outputting that portion of the selected stream data which is designated by said obtained sequence information, in accordance with said obtained sequence information.

27. A stream output apparatus comprising:
a network portion for communication with a device connected through a network;
a stream output portion for outputting stream data applied from a selected input;
a timer portion for generating time information;
a sequence information generating portion for generating sequence information related to stream data being currently output from said stream output portion, including time information representing time of output of said stream information and time particular to said stream data; and
sequence information transmitting portion for transmitting the sequence information generated by said sequence information generating portion to an external device.

28. An information providing apparatus for transmitting, to a terminal apparatus, sequence information designating a sequence for reproducing contents, comprising:
selecting means for selecting sequence information in accordance with a predetermined procedure, in response to an occurrence of a prescribed event, said sequence information including, as information for specifying the contents to be reproduced in accordance with the sequence information, at least time information particular to the contents;
means for determining a terminal apparatus to transmit the sequence information in relation to said event; and
transmitting means for transmitting the sequence information selected by said selecting means, to the terminal apparatus determined in relation to said event, independent from whether a transmission request has been received or not from the apparatus.

29. The information providing apparatus according to claim 28, wherein
said sequence information includes
an item for identifying a corresponding stream, and
information designating, by time, start and end of reproduction in accordance with said sequence information in said corresponding stream.

30. The information providing apparatus according to claim 29, wherein
said corresponding stream of said sequence information is a broadcast program, and
said information item for identifying the corresponding stream includes an information item identifying date and channel of broadcast of said broadcast program.

31. The information providing apparatus according to claim 28, wherein
said sequence information includes a plurality of said information items identifying streams different from each other.

32. The information providing apparatus according to claim 28, wherein
a sequence for reproducing contents of said sequence information includes, at a predetermined position, link information to information held by said information providing apparatus.

33. The information providing apparatus according to claim 28, wherein
a sequence for reproducing contents of said sequence information includes, at a predetermined position, link information to an information page related to sales of a product or service.

34. The information providing apparatus according to claim 28, further comprising:
search condition receiving means for receiving a prescribed search condition from a terminal apparatus;
program information storage means for storing program information;
sequence information storage means for storing sequence information designating a sequence for reproducing contents;
first searching means responsive to reception of a search condition by said search condition receiving means from the terminal apparatus for searching said program information storage means for a program that matches said search condition;
second searching means for searching sequence information corresponding to a result of search by said searching means, in said sequence information storage means; and
means for transmitting a result of search including the sequence information or link information to the sequence information searched out by said second searching means to the terminal apparatus that transmitted said search condition.

35. The information providing apparatus according to claim 28, wherein
said sequence information includes first link information to contents included in a sequence for reproducing contents of said sequence information, second link information to an information page related to sales of a product or service selected in advance in relation to said contents, and contents prepared in advance in relation to said first link information and said second link information.

36. The information providing apparatus according to claim 28, further comprising:
table storage means for storing a table of information transmission destinations respectively in correspondence to sequence information;
means responsive to transmission of said sequence information from said information providing apparatus to a terminal apparatus, for determining an information transmission destination corresponding to said transmitted sequence, by making a reference to said table of information transmission destinations;
means responsive to transmission of said sequence information, for calculating accounting information to be charged on said sequence information; and
means for transmitting the accounting information calculated by said calculating means to the information transmission destination determined by said means for determining the information transmission destination.

37. The information providing apparatus according to claim 36, wherein
said means for calculating accounting information includes means for calculating, based on a number of transmission of sequence information to a specific transmission destination, the accounting information to said transmission destination.

38. The information providing apparatus according to claim 28, further comprising:
search condition receiving means for receiving a prescribed search condition from a terminal apparatus;
sequence information storage means for storing sequence information designating a sequence for reproducing contents;
searching means responsive to reception of the search condition from the terminal apparatus by said search condition receiving means, for searching said sequence information storage means for sequence information matching said search condition; and
means for transmitting a result of search including link information to sequence information searched out by said searching means, to the terminal apparatus that transmitted said search condition.

39. The information providing apparatus according to claim 28, further comprising:
search condition receiving means for receiving a prescribed search condition from a terminal apparatus;
program information storage means for storing program information;
sequence information storage means for storing sequence information designating a sequence for reproducing contents;
first searching means responsive to reception of a search condition from a terminal apparatus by said search condition receiving means, for searching said program information storage means for a program that matches said search condition;
second search means for searching said sequence information storage means for sequence information corresponding to a result of search by said searching means; and
means for transmitting the sequence information searched out by said second search means to the terminal apparatus that transmitted said search condition.

40. The information providing apparatus according to claim 28, further comprising:
search condition receiving means for receiving a prescribed search condition from a terminal apparatus;
sequence information storage means for storing sequence information designating a sequence for reproducing contents;
searching means responsive to reception of a search condition by said search condition receiving means from a terminal apparatus, for searching said sequence information storage means for sequence information matching said searching condition; and
means for transmitting the sequence information searched out by said searching means to the terminal apparatus that transmitted said search condition.

41. An information providing apparatus for transmitting sequence information designating a sequence for reproducing contents, to a terminal apparatus through a network, comprising:
program information storage means for storing program information including information at least identifying a program and broadcast time of the program;
sequence information storage means for storing sequence information designating a sequence for reproducing contents;
time measuring means for measuring current time;
means for forming program table information dynamically changing with time, from the program information and the sequence information, with reference to current time and broadcast time of each program included in said program information, in response to a request from a terminal apparatus; and
means for transmitting the program table information formed by said forming means to the terminal apparatus that transmitted said request.

42. The information providing apparatus according to claim 41, wherein
said forming means includes means for comparing current time and broadcast time of each program included in said program information, in response to a request from a terminal apparatus, and
means for forming program table information selectively including, dependent on whether the current time is earlier or later than a broadcast end time of a program included in said program information, either one of record reservation information of the program and link information to the sequence information corresponding to the program.

43. The information providing apparatus according to claim 41, wherein
said forming means includes means for comparing current time and broadcast time of each program included in said program information, in response to a request from a terminal apparatus, and
means for forming program table information selectively including, dependent on whether the current time is earlier or later than a broadcast end time of a program included in said program information, either one of record reservation information of the program and sequence information corresponding to the program.

44. The information providing apparatus according to claim 41, further comprising:
means, responsive to registration of sequence information in said sequence information storage means, for forming said program table information at that time.

45. An information providing apparatus for transmitting sequence information designating a sequence for reproducing contents to a terminal apparatus through a network, comprising:
program information storage means for storing program information including information at least identifying a program and broadcast time of the program;
sequence information storage means for storing sequence information designating a sequence for reproducing contents;
means for storing reservation information designating transmission of sequence information related to a specific program to a specific transmission destination;
means responsive to registration of sequence information in said sequence information storage means, for searching, in said means for storing reservation information, a transmission destination that reserved transmission of the sequence information; and
means for transmitting said sequence information registered in said sequence information storage means, to the transmission destination searched out by said searching means.

46. The information providing apparatus according to claim 45, further comprising
means responsive to arrival of a broadcast time of a specific program in the reservation information, for transmitting the program to the transmission destination of the sequence information related to the program; wherein
said means for transmitting the sequence information includes means for transmitting said sequence information registered in said sequence information storage means to the transmission destination searched out by said searching means, in response to completion of transmission by said means for transmitting the program.

47. An information providing apparatus, comprising:
program information storage means for storing program information;
sequence information storage means for storing sequence information designating a sequence for reproducing contents, related to the program information stored in said program information storage means;
transmission destination storage means for storing, for each destination of information transmission, information identifying destination of information transmission and condition for searching a program;
program searching means for searching said transmission destination storage means for a program that matches condition for searching a program; and
means for transmitting the sequence information related to the program searched out by said program searching means to a transmission destination stored in said transmission destination storage means.

48. computer readable recording medium storing a computer program that, when executed by a computer, causes said computer to operate as the information providing apparatus according to claim 28.

49. The stream output apparatus according to claim 1, wherein
said sequence information further includes output control information for changing speed of reproduction of said stream data.
